(19) United States
(12) Patent Application Publication
(10) Pub. No.: US 2004/0036715 A1
(43) Pub. Date: Feb. 26, 2004

(54) Multi-level user help

(76) Inventor: Peter Warren, Chattanooga, TN (US)

Correspondence Address: GREENBERG-TRAURIG, 1750 TYSONS BOULEVARD, 12TH FLOOR, MCLEAN, VA, 22102, US

(21) Appl. No.: 10/227,409

(22) Filed: Aug. 26, 2002

(51) Int. Cl. G09G 5/00

(52) U.S. Cl. 345/713; 345/707; 345/715

(57) ABSTRACT

A method for displaying multi-level help for an element of a computer system through creating a hierarchically organized plurality of help levels for the element in which each help level includes an associated help item. The computer system then receives a help activation command for that element from the user and responds by displaying a help item for the element of an initial help level. A user may also edit the help item or create a new help item for one of the plurality of help levels or a new help level. Additionally, each user of the system may edit and create user specific help items, and these help items may be created, edited and implemented “on the fly.”

### REFERENCE TO RELATED APPLICATIONS

This application claims the benefit of commonly-owned U.S. patent application Ser. No. 09/712,581 entitled “Any-To-Any Component Computing System” and commonly-owned U.S. patent application Ser. No. 09/710,826 entitled “Graphical User Interface,” the entire disclosures of which are incorporated herein by reference.

This application is related to U.S. patent applications entitled “DYNAMIC DATA ITEM VIEWER”, “CONFIGURABLE TYPE-OVER TEXT BOX PROMPT”, and “STRUCTURED FORMS WITH CONFIGURABLE LABELS”, filed Aug. 26, 2002 by inventors Peter Warren et al., the entire disclosures of which, including the technical letters incorporated therein, are incorporated herein by reference.

### TECHNICAL FIELD

This invention relates to computer software and, more specifically, relates to a multi-level user help, having separate help items for each level as well as a user specific initial help level, for an element of the software in which multiple users may edit and create user-edited help items for pre-existing help levels or newly created help levels.

### BACKGROUND OF THE INVENTION

The capabilities of software constructed with conventional approaches are inherently limited due to the fundamental nature in which the software is constructed. In particular, virtually every type of conventional software is constructed as one or more large masses of executable code that is written in one or more source code files, which are compiled into one or more executable files, which typically produce interrelated output data of various types. The format of the output data, and the screen displays rendered by the software for showing the output data, are integrally controlled and set up by the executable code, which may further involve integral cooperation with facilities provided by the operating system and other applications, such as commonly-accessed objects, DLLs, device drivers, and the like. Once compiled, the executable files can run on an appropriately equipped computer system to implement the pre-configured functionality and render the pre-configured output screens. But the resulting software infrastructure is inherently limited because it is very difficult to vary software constructed in this manner from the pre-configured functionality originally built into the software. This is a systemic problem with the conventional software infrastructure, which currently limits the ability of this infrastructure to progress in an evolutionary manner.

Specifically, once a particular application has been written and compiled in the conventional manner, the functionality of the application is inherently limited to the functions that the developers anticipated and built into the executable files. Any change to the pre-configured code, or the data structures, or the visual output capability, requires digging into the original source code, writing programming changes at the source code level, debugging and testing the altered code, and recompiling the altered code. Once this task has been completed, the software application is again limited to the functionality that the developers anticipated and built into the updated executable files. But the updated executable files are just as inaccessible to the user as the original files, which again limits the functionality of the software to the functionality built into the newly updated executable files.

As any software engineer can attest, the process of updating conventional software in the manner described above becomes increasingly difficult as the software becomes increasingly sophisticated. Even conceptually simple tasks, such as implementing software changes while maintaining backward compatibility with files created using earlier versions of the same software, can become vexingly difficult and in some cases technically impractical or economically infeasible. Indeed, the “Y2K” programming challenge taught the industry that implementing any type of programming change to conventional software, no matter how conceptually simple, can draw the programmers into a nearly impenetrable morass of interrelated instructions and data structures expressed in a complex system of executable files that typically cannot share information or functional capabilities with each other without tremendous effort.

In general, this programming inflexibility ultimately results in limitations imposed on the sophistication of software, limitations imposed on the ability to integrate existing applications together into cooperating units, and limitations imposed on the scope of potential users who can effectively use virtually any type of software built using the current infrastructure. As a result, much of the world remains computer illiterate, while the remainder struggles to deal with the current system, which includes a staggering number of enormously complex executable files. In addition, recent increases in computer hardware capabilities remain substantially underutilized because conventional software cannot effectively be extended to take advantage of the new computing capabilities. The end results include hardware and software industries that both appear to be stymied, waiting for a solution that will allow significant progress to proceed on both fronts.

From a more personal point of view, the conventional software infrastructure effectively shifts serious burdens from the software (or, more correctly, from the programmers who wrote the software) onto those persons least equipped to deal with them, such as new users trying to learn how to use the programs. This occurs because the programmers must necessarily develop a system of documentation to assist the users in understanding how to use the software, which is an expensive undertaking that generally increases with the amount of documentation provided. The most expedient approach often involves creating the least amount of documentation that one can reasonably be expected to get away with in the current market, and letting the users “fend for themselves” or buy a different product.

For example, one type of help documentation includes pop-up user interface screens that display text-based help items “on the fly” under the control of the underlying software. However, due the limited size of the display screen, the amount of information that can be communicated in this manner is very limited. This limitation is exacerbated when the display screen is very small, as occurs with hand-held PDA devices, wireless telephones, and the like. In addition, too many help screens that pop-up automatically without user control can be an annoying impediment. Although menu-driven help screens can decrease the reliance on automatic pop-up screens, they can be cumbersome and time consuming to use. To make matters worse, the prevailing market forces apparently dictate that inexpensive small-screen computing devices come with the thinnest, most puzzling types of printed and on-screen documentation. In sum, the shortcomings of conventional help documentation appear to present a formidable near-term barrier to bringing inexpensive small-screen computing devices to much of the computer-illiterate world. Unfortunately, this condition may significantly delay the realization of very widespread distribution of inexpensive computing devices with the capacity to bridge the technology gap that currently separates the computer “haves” from the computer “have-nots.”

In practice, different users typically display different levels of experience and proficiency in utilizing elements of a software program. One user may be extremely inexperienced with an element of the software program and require significant instruction on the use and/or functionality of the element, while another user may be highly proficient, in relation to the element, and need only a cursory help explanation. In the latter case, a lengthy explanation would decrease the more advanced user's efficiency by forcing him to wade through the additionally material. Additionally, a user may become more experienced in using elements and need less of a help description in subsequent help requests.

Moreover, because the same pre-configured user interface screens are necessarily displayed for all users regardless of their familiarization with the software, the on-screen displays are typically limited to information that “most” users can find helpful, and this is typically incomprehensible to the newcomer and inadequately specific for the expert. For more detailed information, the user must resort to a pre-configured help utility or a printed manual. These resources, of course, are similarly limited to pre-configured information and notoriously difficult to use and understand and although “context sensitive” in some cases, are still inadequately germane to the matter at hand and although assisted by probability or other mechanisms in other cases, are often so far from the mark as to be nearly useless in many instances. Partly as a result of this, many new users are intimidated from getting started with a new software program, and many of the sophisticated functions built into the software remain unused, even by long-time users. Despite an enormously expensive training and support infrastructure that has developed to support conventional software, the promise of increasingly sophisticated software remains constrained by steep learning curves, ineffective documentation, inadequate and overly expensive training options and long and expensive deployment.

Moreover, because the same automatic user interface screens are necessarily displayed for all users regardless of their familiarization with the software, these on-screen displays are usually limited to displays that “most” users find “most” helpful “most” of the time, which are all too often incomprehensible to the newcomer and inadequately specific for the expert. For more detailed information, the user must resort to other less obvious resources, such as menu-driven help documentation or printed manuals. In general, these resources are notoriously cryptic, and remain so despite the best intentions of many highly skilled authors. For example, although some of these resources are “context sensitive,” they may still be inadequately germane to a particular matter at hand, especially when that matter was not fully anticipated by the author of the documentation. Even when assisted by probability or other conventional mechanisms, these resources often miss the mark so badly as to be nearly useless—typically when the user needs them most. Partly as a result of these systemic limitations, new users are often intimidated from getting started with new software programs, and many sophisticated functions built into the software programs remain unused, even by long-time users.

Another important practical effect of the limitations experienced by conventional software appears when a user or developer would like to translate an application into a foreign language. Because much of the text displayed by the application is embedded within executable files, a commercially viable set of labels, prompts, messages and help screens cannot be translated into another language without digging into the source code, changing the text at this level, and then recompiling the code. For a sophisticated software application, this process can be extremely time consuming, expensive and difficult, and generally requires an expensive team of highly skilled programmers to complete. As a result, it is impractical or economically infeasible to translate many types of software into a very wide selection of languages that would ensure its greatest use. For this reason, many software applications remain limited to their original human language, and even when an application is translated, it is typically limited to the world's four or five most-used languages. This limits the markets for these products, which deprives much of the world from the benefits that it could enjoy from access to powerful software applications.

To illustrate another practical limitation of conventional software, consider an organizational environment in which part of a document, such as an accounting spreadsheet or briefing document, is required reading for certain employees while other parts of the document contain confidential information that is off-limits to those same employees. One attempted solution for this conundrum involves creating different versions of the same document suitable for distribution to different users. This approach immediately multiplies the complexity of document management and brings into play challenging problems, such as having to store multiple versions of the same document, having to keep multiple versions of the same document coordinated with a base version that changes continually, and so forth. If the document contains sophisticated code and large amounts of data, the resources required to store and maintain duplicate copies can be a significant factor.

Moreover, regardless of the resource requirements, the administrative difficulties can become extreme when the objective is to make extremely sensitive information available in accordance with an intricate system of access rules. Common examples of these types of applications include financial accounting systems and security clearance-based access systems. In these situations, the only cost effective way to ensure an adequate level of confidentiality may be to implement a document management system that prevents all of the software, or all of its data, from being accessed by anyone except a very limited number of “authorized” persons. At the same time, however, it would be far more efficient if appropriate portions of the application could be freely accessed by a variety of “non-authorized” or “partially-authorized” persons.

In the current state of the art, an additional conundrum occurs when different persons in an organization need to be able to do different things to a particular type of data. For example, several different persons may have a need to perform different activities using a particular type of data. Prior attempts to solve this problem include the development of commonly-accessed spreadsheets, in which certain cells of the spreadsheet, or the entire spreadsheet, can be “locked” and only accessible via a password. Unfortunately, this type of functionality is not generally available to the users of other application programs, such as word processing, presentation software, database software, and the like. Moreover, even in the spreadsheet programs containing this type of functionality, the solution has thus far been so inflexible that the ability to make changes to a particular spreadsheet is either black or white. That is, the only available choices are to allow a particular user to change all the data and functions in the spreadsheet, or to make that user unable to input any changes at all.

To make matters worse, it is very difficult to resolve this problem in current software programs because the inability of these programs to make data and functionality available on a user-by-user or item-by-item basis is deeply rooted in the programs at the source code level, and therefore has little or nothing to do with the type or sensitivity of the data produced or maintained by the software. As an example of this problem, consider a briefing document that contains some confidential parts and other non-confidential parts suitable for public consumption. In this example, the organization controlling the document may want its staff to read the entire briefing, but does not want any of the confidential parts to be sent to outsiders. At the same time, the organization may have a policy the permits outsiders to read the non-confidential parts of the document, for example in response to a valid Freedom of Information Act request. Typically, a word processing program or an e-mail program can either send out everything it can access, or can't send out anything. Hence, if an employee reads such a document using his word-processing software, he can also send it out by e-mail, which can undermine attempts to control subsequent distribution of the document and lead to considerable embarrassment for those concerned.

This problem occurs because conventional software is limited in that it cannot make individual elements of data or functionality available, or unavailable, on a user-by-user or item-by-item basis. For example, in the situation discussed above, a particular briefing created for public consumption cannot contain any confidential data, while a briefing on the same subject matter containing a relatively small amount of confidential information must be restricted to a small class of authorized persons. In very high-security environments, the only practical way to deal with this problem may be to create an “air-wall” in which the internal system has no connection to the outside world whatsoever, which causes additional problems including inefficiencies at the human level.

Despite an enormously expensive training and support infrastructure that has developed around the conventional software industry, the promise of increasingly sophisticated software remains constrained by steep learning curves, ineffective documentation, inadequate and overly expensive training options and long and expensive deployment cycles. Consider again the accounting example in which a salesman should certainly be able to see if his client's payment has arrived, but he cannot because he is not fully “authorized.” The root cause of this problem lies in the inflexibility of the underlying software, and the only practical alternative to fixing the software effectively shifts the cost of the problem onto the humans involved, in this example by requiring the salesman to expend considerable time “talking to the accounts department” to obtain data that ought to be freely available to him in the first place. Not only does this so-called solution waste the salesman's time, it also disturbs at least one other person working in the accounts department. Eventually, entire job descriptions center around tasks created by software programs. Put somewhat differently, the current software infrastructure shifts very significant burdens onto the humans involved, rather than the other way around, which is serious problem indeed.

Therefore, a need exists for an improved paradigm for constructing software that overcomes the inherent limitations of the conventional software infrastructure. A further need exists for improved methods for controlling the exposure of data and functionality of software on a user-by-user and item-by-item basis. And a further need exists for incorporating helpful instructional capabilities into software that can be effectively targeted to particular matters that confront users of all skill levels.

### SUMMARY OF THE INVENTION

The present invention contributes to a new software paradigm that meets the needs described above in a method for providing multi-level help for users associated with an element. The methodology of the invention may be implemented on a host computer system, which may be local or remote, or it may be expressed in computer-executable instructions stored on a computer storage medium. In this context, a “host computer system” refers either to a local computer at which a person is working, or to a remote computer that stores the data, stores the software, stores the input/output control information, controls the local system or performs some other function involved in the implementation of the methodology, or combinations of local and remote components performing the methodology.

A help item is displayed upon element activation, providing information for the user on the aspects, use and/or functionality of that element. The term “element activation” refers to any manner of causing the help item to be display for an element, be it a mouse click, cursor movement, keystroke(s), voice command, sequence of events, time delay, or the like. Additionally, the user may edit the help items to allow for ease of use and understanding, as well as possibly making the software experience more enjoyable and “individualized” for each and every user of the system. For example, the user can easily translate the help items for a particular help item into a foreign language, add user-selected elements to the help item, provide additional information with the help item, add personalizations such as graphics, video and sounds to the help item, and so forth. Further, the help items displayed may be edited, as described above, during an uninterrupted user session.

Generally described, the invention includes a method for displaying help for an element on a host computer system. The element can be a component in a software program, which is created by a software programmer, data, or a use thereof. The component or data may be created by either a programmer, designer, or user. The element typically can be associated with a functionality, data, or is a combination thereof.

This functionality and/or data “association” may be from the use of Data Relation Table (“DRT”) records, which are described in the incorporated references as well as subsequently. The programmer may provide the ability to create a hierarchically organized plurality of help levels for the element as well as the ability to create and include an associated help item for each help level. Upon receipt of an activation command for an element, the software responds by determining an initial help level for that user and then displaying the help item that has been associated with that level. This help item may be included in a help window, which, in turn, may provide scrolling elements for scrolling through help items.

This method may be performed during an uninterrupted user session. Additionally, a computer storage medium may be created comprising computer-executable instructions for performing this method. An apparatus may also be created to perform this method. An active element is any discrete entity visible, or available to be made visible, on a screen or by other output alternatives, including audio, tactile and other such means. The element, with which the help item is associated, may be an active element. The system may display the help item, when visual, in various locations in relation to the element or in relation to a relative position on the screen or in relation to another element.

The system may allow user editing of a pre-configured help item by receiving the user edits, saving those edits, and later displaying them in place of the pre-configured help item upon a subsequent activation of the element. This help item editing may edit a currently existing help item or this help item editing may create a help item for a level that does not have a pre-configured help item. Therefore, a user-edited help item is created from a pre-configured help item, a user-edited help item, or from a “blank,” thereby creating a new help item. A pre-configured help item is one that has been created at an earlier point in time to the present point in time in a present user session, and may have been created interchangeably by a programmer, a designer, or by that or another user.

The system may maintain, in memory, the pre-configured help item and display a help item selection utility, which allows the user to select between viewing the user edited help item and the pre-configured help item, and subsequently displaying the selected help item upon activation of the element to which it is associated. The system may allow additional user items to be edited in association for the element either by the same user or by another user. Then the selection device can allow user selection between these user-edited help items and the pre-configured help item, and subsequent display of that help item. It should be noted that these programmer and user created help items can comprise a plethora of item types, including text, graphics, video, sounds, links, applets, other assorted functionalities or a combination thereof.

Upon activation of an element, the system displays the initial help level. The system may determine this initial help level as a property user-specification, the most recent help level viewed by the user, the highest help level viewed by the user over a period of interest, or a weighted averaging of the prior help levels viewed by a user over a period of interest.

The element may be assigned to a group and the element's initial help level may be based on the group's initial help level. This group initial help level may be defined by the user relating elements into a group and sending the group settings to the system. Alternatively, the groups may be created based on similarities in the help levels view by the user. Then, through an analysis of the help levels viewed by the user, the group initial help level may be set or alternatively the user may set that himself. Another method of setting the group initial help level may be through basing the help level on a weighted average of help levels viewed for elements within the group over a period of interest.

Essentially, the difference between someone who can use today's software and someone who cannot, is the understanding and knowledge level the person has acquired. This understanding may be acquired either through someone else explaining things to him, from a course, from their own exploration and understanding of today's help, from experimentation, or from any combination of these. Hence, a key factor in enabling a person to use a computer either at all, or for a specific purpose, is for the computer to supply, in an adapted and comprehensible fashion, enough information of sufficient clarity and flexibility as to replace the instruction and understanding he may obtain elsewhere. This information must be provided in such a fashion as to make it as comprehensible as the information typically received from the other sources discussed prior. This invention enables any software to provide, under the general descriptive title of “help”, that necessary, adapted, and comprehensible instruction of high clarity and relevance that has been missing in software to date and to enable it to be supplied in a multiplicity of languages with programmer assistance, and whose omission has materially reduced the usability, user enjoyment, and hence sales of computer software.

The specific techniques and structures employed by the invention to improve over the drawbacks of prior systems for displaying help items in a computer environment and accomplish the advantages described above will become apparent from the following detailed description of the embodiments of the invention and the appended drawings and claims.

### BRIEF DESCRIPTION OF THE DRAWINGS

FIG. 1 is a functional block diagram of an EXOBRAIN system in which the present application may be implemented.

FIG. 2a is a depiction of a prior art user interface including menu items.

FIG. 2b is a depiction of a prior art pop-up help display for a menu item.

FIG. 3a is a depiction of an embodiment of a user display for the present invention.

FIG. 3b is a depiction of an embodiment of an element activation along with a display of a help item for a first help level.

FIG. 3c is a depiction of an embodiment of an element activation along with a display of a help item for a second help level.

FIG. 3d is a depiction of an embodiment of an element activation along with a display of a help item for a third help level.

FIG. 4a is a depiction of an embodiment of a grouping of the elements.

FIG. 4b is a depiction of an embodiment of group initial help levels for a plurality of users.

FIG. 5a is a depiction of an embodiment of user of control elements with the help window.

FIG. 5b is a depiction of an embodiment of a user utilizing a more control element to increase the help level.

FIG. 5c is a depiction of an embodiment of a user utilizing a less control element to decrease the help level.

FIG. 5d is a depiction of an embodiment of a user utilizing a modify control element to modify the help item, activation of the help item edit window, and editing of a user-edited help item.

FIG. 5e is a depiction of an embodiment of a user utilizing the help item edit window to save a user-edited help item.

FIG. 5f is a depiction of an embodiment of a user utilizing the help item edit window to add a file or a link.

FIG. 5g is a depiction of an embodiment of an added file following a user utilization of the help item edit window to add the file.

FIG. 5g is a depiction of an embodiment of an added link following a user utilization of the help item edit window to add the link.

FIG. 6a is a depiction of an embodiment of an example DRT table showing DRTs for an element, a group, default help items and user-edited help items.

FIG. 6b is a depiction of an embodiment of example DRTs for non-text help items.

FIG. 6c is a depiction of an embodiment of an example DRT for view properties for the .gif file as depicted in FIG. 6b.

FIG. 7 is a flow-chart representation of an embodiment of the method of the present invention.

FIG. 8 is a flow chart representation of an embodiment of the subroutine for determining the initial help level.

FIG. 9 is a flow chart representation of an embodiment of the subroutine for displaying the help item for the initial help level.

FIG. 10 is a flow chart representation of an embodiment of the subroutine for displaying allowing help item editing.

FIG. 11 is a flow chart representation of an embodiment of the subroutine for displaying allowing help modification.

### DETAILED DESCRIPTION OF THE EMBODIMENTS

The present invention meets the needs described above in a method for displaying multi-level help items associated with an element or a group of elements. Default help items may be created for each element by a programmer, a designer or by that or another user. These elements are typically active elements, including screen elements. Active elements are any element with which the user can interact. A screen element is an element that is visible on the display screen. Often, these elements provide links or “pipelines” to a data file or software functionalities. In the preferred embodiment an EXOBRAIN™ system is used, in which data files and software functionalities are stored in a data relation table (“DRT”) or any structure serving the same or a similar purpose for the purposes of this invention. In this manner, the appropriate code results in these elements “directing themselves” to, linking to, or acting as a “pipeline” for a specific field of a specific DRT record, which in turn may link to additional DRT records. The present invention may be embodied in applications constructed using a new software paradigm known as an EXOBRAIN™ system. This trademark, which is owned by ExoBrain, Inc. of Chattanooga, Tenn. refers to an any-to-any component computing system as described in U.S. patent application Ser. No. 09/712,581, and a related graphical user interface as described in U.S. patent application Ser. No. 09/710,826, which are incorporated by reference. This system is further described in the technical letters appended to the co-pending application of Peter Warren entitled “Dynamic Data Item Viewer” filed Aug. 26, 2002, which are also incorporated by reference. The technical letters include a descriptive table illustrating the structure and functionality of a data relation table (DRT) along with several text files describing the construction and use of the DRT in implementing an EXOBRAIN system. It is important to appreciate that in an any-to-any machine, every type of data item, even one as elemental as a single letter, may be represented in fields contained in the DRT. While this aspect of the embodiments described below facilitates the implementation of the invention, this does not in any way limit the scope of this invention to an any-to-any machine.

In addition, the ability to access particular help items and to make, or not make, any of the particular changes described in this specification in particular or in general, can be related to particular persons with particular authorities. Although this invention is described in relation to visual input and output, the mechanisms described are not necessarily an inherent part of either the software that manipulates the data concerned or of the graphical user interface (GUI). Accordingly, the various software components, functionalities, and structures described herein may be implemented separately or in combination with each either. Further, the mechanisms described in this specification are equally applicable and able to control those of the described features applicable to non-visual input and outputs, such as tactile input and outputs, verbal input and output (such as text to speech and voice recognition), and to inputs and outputs between machines, and to any operative combination of these. Accordingly, where the word “display” is used in the description that follows, this use should be interpreted in its broadest sense to include audio, visual and other human-detectable or machine-detectable modes of communication, as well as the acts of showing, playing, performing or executing any sort of data or instruction, or any combination or permutation of these.

It should also be understood that, although the following description explicitly concerns the example of altering pre-configured help items, the same techniques may be used to create such a help item and display it in the first place. In view of this factor, the concept of a pre-configured help item encompasses the null set, in which the pre-configured construct is a blank or empty item. That is, the principles of the invention may be used to create the first and initial help item—effectively creating that new help item—as well as to alter previously created help items. In addition, a pre-configured help item may be constructed by programmers or by designers and included as part of the code supplied to a user, or they may be created or altered by users through the use of the functionality and structures included in the underlying programming or they may be created by third parties, and then shared with the user. For example, a third party may utilize the present invention to create help language translations for the user without the need, as in prior art, to have either programming expertise, or a team of programmers standing-by, essentially “looking over the shoulder” of the translator or vice-versa. One can readily appreciate the added cost and time delay associated with the need for multiple expertise in creating a language translation for help items. Additionally, it should be understood that all help items, typically without exception, may be changed “on the fly” through user input, thereby avoiding the cumbersome need to quit the program, modify the program, recompile the program, and reinitialize the program. Thus, programmer-created help items, and help items created by non-programmer designers from a company commercializing software, are an optional, but not an essential, part of the product to be delivered to a user.

In addition, the host system, which may include local and remote components, stores the user-defined help items for subsequent access, and displays the help items in association with their elements, without the need for additional programming changes. This computing infrastructure is fundamentally different from today's software infrastructure, in which a help item must be created by a programmer and rendered by the executable code. In addition, a default help item is typically defined for the element, and since the flexibility available has the capacity to allow the help item to be distorted beyond recognition or use, typically, this default help item (as well as any others) can by “locked” so that it cannot be removed or changed by an inexperienced or unauthorized person. However, the presence or absence of any particular data that is present in a particular help item does not in any way affect the underlying data that may be there. Conventionally, and especially in existing database software, removing a help item from visibility results in the loss of the data that had been stored in the removed help item. But this is not the case with the user editable help item as described herein, in which the help item—for example the selection or removal of particular user-edited help item for an element—has no effect on the existence or otherwise of the underlying data or that help item, or other associated help items. In fact, it is also possible to arrange the system so that, for a given element, some of the help items—for example, a particular user-edited help item—is visible while another combination of pre-configured and user-edited help items that are not visible (but which may also include any of the help items) are being used to specify the help item shown in the help window. In conventional Query By Example (QBE) implementations, the fields used to query by an example are typically the same fields in which the result of the query is shown. In the user editable help item, on the other hand, that limitation does not have to occur. For example, two or more help items may be displayed simultaneously, one of which may be used as the QBE input, while the other view may display the results of the QBE query with the field selection or the targeted record type/s or both may be different in each.

Further, the host system may also display a user-accessible selection utility for selecting between the default help item and other user-edited help items. The host system then receives a selection command in association with the user-accessible selection utility indicating a selected view among the default and the user-defined views and, in response, displays the data item in association with the selected view.

For example, when utilizing the system, each of these help items may be associated with a help level and the help item may be displayed in a help window. A help window may assume a particular form or format; such as a pop-window, such as a “speech bubble,” or can be “formless” so the help item is the only visible, or audible, aspect of the help “window.” Additionally, the help window may be more than a single display window to facilitate the view of a help item. The help window can be configured to have various characteristics including: text size, color and font; background properties; color; position; and included elements.

For example, the help window may may contain an included element which is a control element. These control elements may provide user control over aspects of the help window, including the shape, size, position, text scrolling, help level scrolling, initialization of a help edit window, and an ability to close the help window. The help level scrolling may be done with help level scrolling elements, which allow the “scrolling” of the help levels associated with the element. These help level scrolling elements may be visual elements, typically buttons (such as “more” or “less” buttons), which allow for increasing or decreasing the help level. Additional visual elements of the help window can include “quit” or “close” buttons, which quit or close the help window, as well as an “edit” button which can initiate the editing functionality for the help item). This editing functionality is discussed in further detail later. It should be understood, as these buttons are elements, each of these visual elements can, in turn, activate their own help windows. Other visual elements may include “grow” or “shrink” buttons or functions activated by buttons or in another manner, which would make the help window larger or smaller, or a “move” button, which would allow movement of the help window on the screen.

Returning the reader's attention to the help items, these help items may be pre-configured help items. Such pre-configured help items, or default help items, are typically included by the software developer, or by a non-programmer designer or an affiliate of the software developer, and provide the various “default” help level items for the element. Typically, in an EXOBRAIN™ system, the programmer does not provide any specific help item, only the ability to create and change help items for any element or combination of elements and thereafter, it is designer or the user who creates specific help items, adds default text and the like. Alternatively, these help level items can be edited by a user, where the edited help item is displayed in place of the default help item for that level.

In the present application “edited” help items, include the modified help items and new help items. Modified help items may “start” with the pre-configured help item and allow the user to modify it. New help items may start with a “clean slate” and allow the user to create, from the “ground up,” a new help item for an existing level or for a “new” level, for data, which did not previously have an associated help item. Note also that, in an EXOBRAIN system, as functionality is implemented in a generic, generally applicable manner, it may be implemented that a help item may itself have its own help item, and the process can be continued indefinitely if wished.

It is preferable to allow this editing during an uninterrupted user session, which is typically implemented on a host computer system. This method of the invention may be implemented in computer software that is resident on any type of apparatus or computer storage medium. In the context of the invention, the term “uninterrupted user session” means that the host system performs the recited method “on the fly” during a continuous and substantially uninterrupted user session.

For example, the host system performs the recited method without having to interrupt the user session to recompile the underlying code, reboot the system, or restart the application implementing the method. Thus, multiple users may edit the various help items, store the help items and display the help items associated with the elements “on the fly,” which greatly improves the capabilities and understandability of any application implemented on the host computer. In particular, any user can edit help items “on the fly” to create customized help items for a virtually unlimited range of purposes, such as implementing language translation, creating training platforms, customizing help items for special purposes, customizing help items for other persons, and so forth.

However, the help window for each element, or group of elements, can be displayed in a particular manner or screen position. For example, the help item may be preferably displayed in a help window. This help widow may be displayed in a constant location, such as the top of the screen, or over the element concerned or in any place the user wishes. These locations may be adjacent to the element, in a user-defined location on the display, in a pre-configured location on the display or over all or part of the element. In the case of the help element being substantially adjacent to the screen element, the help item can be placed in the “clear space” about the element which the help item is intended to assist. This clear space is where there is “room” for display of the element and the help item simultaneously. A clear space subroutine, which in an EXOBRAIN system is user-controllable, may be included in the software to check for room to the right, below, above and then to the left of the element. One skilled in the art will appreciate alternatives to the described clear space routine. Additionally, the display of the help window can vary based on the help level displayed for the element, the associated element, grouping of the associated element, or even for the help item itself. In the latter case, each help item for the element may be displayed in unique locations compared to one another.

The help item typically comprises text, but can be, or include, video (such as QuickTime™, MPEG or Shockwave™), sound (such as .wav, .aiff or .mp3 files), graphic (such is .pict, .gif, .tiff or .jpeg files), executable software, or other functionalities, including functionalities provided in an applet (such as a JAVA™ Applet). These additions may facilitate the understanding of the user, as well as make the software experience more enjoyable for the user. For example, the sound file could be an “on-the-fly” generated text-to-speech sound, which “speaks” the text in the help box, or “feed” it to a telephone line, or it could simply be a one or more sounds to “catch” the users attention or assist in the user's enjoyment of the software. Alternatively, the sound file could be a recorded instruction on the functionality of the associated element, either pre-configured by the software designer or by the user. This recording may be in one or more languages and may be made selectable by the user or by the system. In the case of using a graphic, a depiction of the functionality of the element can be shown (e.g. a disk for a save functionality or a printer for the print functionality) or simply a graphic to draw the user's attention to the help item. In the same manner, a video may be used to assist in advancing the user's understanding, to gain the user's attention, to increase the user's enjoyment of the software, or a combination thereof.

It should be understood that editing the help item includes the ability for the user to customize the display for the item. The customizable features of a help item include a border, shape, and background of a view area for the help item. Any of these items may include text in any font, size, color and style selected by the user, and may also include multi-media features such as an image, sound, or animation.

The help window may be displayed upon activation of the element. This activation can be done by “selecting” the element with the cursor (typically a “click” or a keystroke while the cursor is “over” the screen element) or by simply moving the cursor over the screen element. Alternatively, an element can be “activated” by I/O functions including mouse movement, cursor location, one or more particular keystrokes, voice command, or the like. Furthermore, an element may be activated by being the “next step” in a process, where the help item is automatically displayed, as a part of a sequence of steps, which may assist in guiding the user. For example, once the step immediately prior to the functionality of the element has been completed, (i.e. step three of the series is associated with the prior element and where step four is associated with the present element for which element activation should occur) the help item for that element is displayed. Alternatively, the software may detect a delay or absence of entering data, or utilizing the functionality of an element, which typically would be “next” in the series, and “activate” the element to display the associated help item at the current help level.

As discussed prior, the help items associated with an element are assigned to respective help levels. Upon activation of an element, the help item for the current help level is displayed. The current, or initial, help level is the help level that is to be displayed to the user initially. Determining the current or initial help level may be done by user-specification, from information taken from the user regarding the user's experience, the last help level used over a time period of interest, through a weighted average scheme over a period of interest, the time since the element was last used or accessed by the user, or the like. The period of interest may be determined by the programmer, user, the software, or the system. This period of interest may account for the fact that a user, after viewing the same help level repeatedly, tends to retain that information. The weighted average may give more of an emphasis to the most recently viewed help items.

Additionally, the elements may be grouped with other elements. Each element may be assigned to a single group or to one or more groups. It may be useful to group the elements in relation to different similarities in functionalities. Each of these groups may have an associated current, or initial, help level. Therefore, when an element of the group is activated, the current, or the initial, help level for that element will be the same current, or initial, help level for the remainder of the group. Similarly, the methods that may be used for determining the current, or initial, help level for an element are similar to the method for determining the current, or initial, help level for a group. For example, when using a weighted function, a greater emphasis may be placed on one or more elements of the group, as well as placing an emphasis on the time of viewing or other factors.

Alternatively, crossover groupings of an element may be used, placing the element in two or more groupings. For example, an element may display more than one functionality, and therefore be grouped in two or more groups relating to the functionalities. A weighting method can then be applied to the element in this case as well. For example, if an element is 50% function A, 30% function B, and 20% function C, the weighting can be made to represent these values. Equally, a particular help may be applicable under more than circumstance and therefore appear in many different groupings.

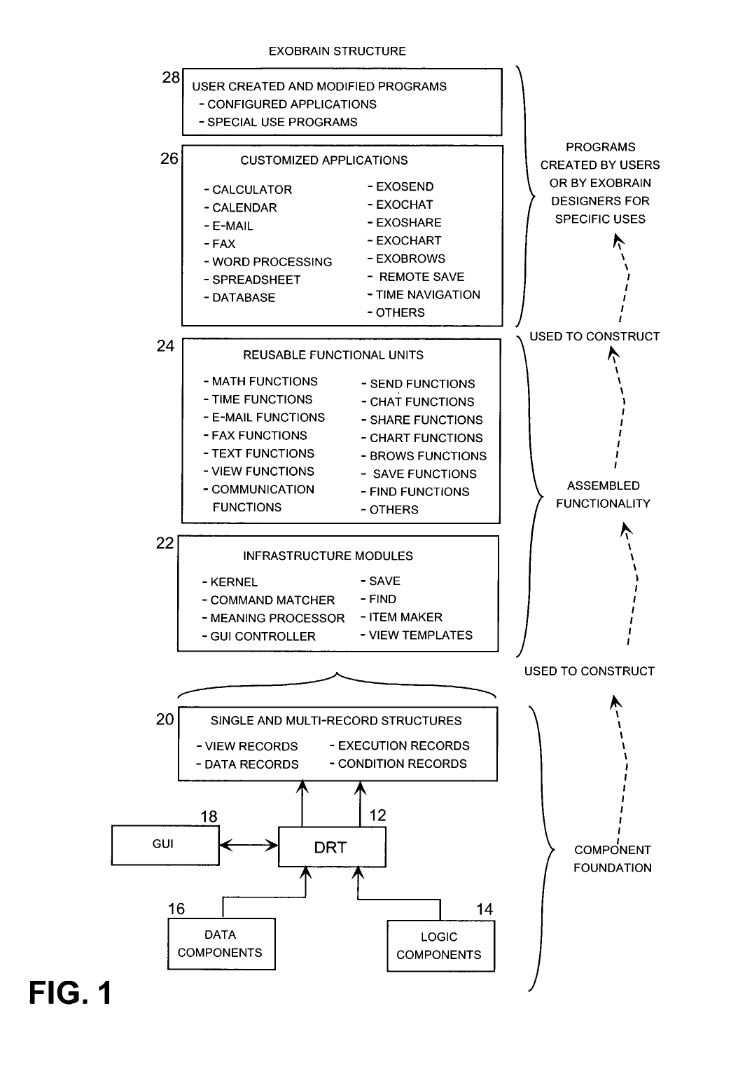

FIG. 1 is a functional block diagram of an EXOBRAIN system 10, in which the the present invention may be implemented. The fundamental elements of the EXOBRAIN are a data relation table (DRT) 12, a set of logic components 14, a set of data components 16, and a graphical user interface 18. The DRT 12 includes a database of records and accompanying functionality specifications in which the structure and methods of the EXOBRAIN system may be implemented. In particular, data and logic may be incorporated into individual DRT records through functionality specifications that may be implemented through administration fields and a data class structure that cooperate with each other to implement a universal interface for recording, accessing, and manipulating any type of data, and implementing any type of software, within the EXOBRAIN system 10. Thus, all applications create in the EXOBRAIN system 10 share a common infrastructure and interface, and may therefore communicate with each other without interface-imposed or data structure-imposed boundaries.

To implement software, the records in the DRT 12 may incorporate compiled software components either directly or by reference to the stored logic components 14, which are a set of compiled software components that can be assembled into higher-level functional units within the DRT structure. Nevertheless, the DRT 12 may also store or reference un-compiled code, which can be compiled “on the fly” using functionality implemented within the DRT structure. In a similar manner, the DRT 12 may incorporate data components either directly or by reference to the stored data components 16, which may be assembled into higher-level data units within the DRT. Although they are shown as external to the DRT 12 in FIG. 1, all types of data, including the logic components 14 and the data components 16, as well as infrastructure modules 22, reusable functional units 24, customized applications 26, user created and modified programs 28 and GUI code 18 may be stored within the DRT and an EXOBRAIN functions best and is most flexible if so stored. For descriptive convenience, however, these items and the logic components and the data components may be referred to or illustrated as items that are separate from the DRT, which is a viable (but merely illustrative) embodiment of the EXOBRAIN system 10.

The graphical user interface (GUI) 18 and the GUI controller 22 collectively provide a mechanism for converting human-communicated data and instructions into DRT format, and for converting DRT-housed data and instructions into human perceptible forms. For example, the GUI controller 22 may drive a conventional computer screen and associated peripheral devices. As noted above, the data class and administration field structure of the DRT 12 create a universal data classification system that allows data and software components to be stored in fields of DRT records. In particular, a component may be included in a field of a DRT record by including the substantive data or software element itself in the DRT record, or by including a pointer in the DRT record. This pointer, in turn, may identify the substantive data or software element, or it may identify another pointer that ultimately leads to the substantive data or software element. In other words, a substantive data or software element that is located outside a DRT record may be incorporated into the DRT record by reference. It should be appreciated that, in the any-to-any system, software components are simply treated as another, specialist form of data. As such, software may be incorporated into a DRT record just like any other type of data. The only difference is that a DRT record containing a software component allows the substantive code to execute when the DRT record is processed, whereas a DRT record containing a data component presents the substantive data elements for manipulation when the DRT record is processed.

Whether data or software, the presence of a particular component in a particular field of a DRT record may be used to relate that component to other components located in the same field in other DRT records. This principle of relating data items to each other based on field location or storage pattern similarity is referred to as a “field parallel” record structure. In other words, a field parallel record structure involves locating components in the same field of different DRT records to connote a relationship between the components. The relationship implied by the field parallel record structure may, in turn, be considered when implementing operations utilizing both components while, at the same time, keeping each component entirely separate from the other in individual records. In addition, the individual records containing components that “go together” may be referenced in a third record, such as a list record. For example, a particular software record may go with a particular set of data records, or a mixture of software and data records. Notwithstanding this operational relationship among the records, none of the records or the data they contain necessarily become part of a programmer-coded construction entity, as would occur in conventional software. This is because the relationships between the components is expressed in the DRT 12 rather than in the compiled code, and the DRT is a database that may be freely manipulated by the user without having to alter the underlying compiled code.

As a result, higher-level software applications may be implemented within the DRT 12 by referring to the compiled code residing in the logic component table 14 and the individual data components residing in the data component table 16 without having to alter the underlying logic and data components, and without having to compile the higher-level software. In other words, the DRT 12 implements a vehicle for assembling the underlying logic components 14 and data components 16 into single and multi-record structures 20 for incorporating all types of data and implementing all types of software functions within the DRT 12. Specifically, the single and multi-record structures 20 generally include data records for incorporating data items into the DRT 12, execution records for incorporating software items into the DRT 12, condition records for specifying conditions for executing a corresponding execution record, and view records of different types for specifying elements to displayed in connection with a corresponding data item as well as other types and sub-types of records.

These single and multi-record structures 20, as well as individual logic components 14 and individual data components 16, may be used to create infrastructure modules 22. These infrastructure modules 22 implement reusable functionality that in most cases is not normally directly accessed by the user. The infrastructure modules 22 typically include a kernel for integrating the EXOBRAIN system with the operating system and other external hardware and software elements. The infrastructure modules 22 may also include a command matcher module that enables command output from either a meaning processor or the GUI 18, or both, to be matched to specific execution records. The infrastructure modules 22 may also include a GUI controller to connect the records of the DRT 12 with the GUI 18. The infrastructure modules 22 may also include a meaning processor for resolving language data into numbers concept language, using numbers concept language records stored in the DRT 12. This enables the EXOBRAIN system to receive commands in natural human language, translate them into correctly formatted DRT records containing the correct numbers concept language values, and output records that are ready to be matched by the command matcher to specific execution records or to records that kick off suitable executions records or logics when they are selected by the matching process.

Referring now to the interrelated operation of the infrastructures modules 22, when the EXOBRAIN system 10 first starts, the bootstrap logic, which instantiates and initializes the EXOBRAIN system, supplies the GUI controller with an initial view, which is used as a desktop but is otherwise a view like any other. In this particular embodiment, the GUI controller is not necessarily a single or multi record structure, but may be compiled code that accepts DRT records as input and outputs commands that drive the GUI 18, which is described in U.S. patent application Ser. No. 09/710,826 entitled “Graphical User Interface.” The GUI 18, in turn, interfaces with the keyboard, mouse, speakers and other input-output devices via the Java run-time structure that effectively interfaces between the Java class files and the underlying operating system. Equally, if Java is not being used, the equivalent functionality can be constructed in any other suitable programming language.

The desktop view typically contains buttons that enable the user to implement a sufficient menu of functionality to get the system started. Optionally or alternatively, the desktop may include a talk box into which commands can be entered for subsequent processing by the meaning processor. Although a visual input-output mechanism is used as an example in this specification, the same general principles are applicable to, and provide a foundation for, a non-visual input output system, such as text to speech combined with voice recognition (speech to text), although additional and obvious parts may be required to implement these capabilities.

The mechanisms for implementing a button are described below to illustrate the principles that are generally applicable to all active elements in the EXOBRAN system 10. Briefly, “active elements” may be used to implement all of the elements displayed by a user interface, such as a button, a box, a sound, an executable instruction, etc. Any particular button is usually represented as an independent record of its own (button) type, which contains in its different fields all the appropriate parameters to specify the display and activities of that button. This record may be a list record that identifies other records, or it may specify the button's parameters in a vector referenced in the method field or in an alternative suitable field that is a standard part of every DRT record. Alternatively, otherwise unused fields on other records may be used to store the appropriate parameters to define a button in a standard manner for all buttons. In any case, the administration fields in the DRT 12 are used to designate particular record types, including the button record type and all other record types. In addition, administration fields designated as “Name” or “Given Name of This Item” and associated sub-type fields may be used in a standard manner to permit all button records to be located with a “find specification,” which sets forth a set of record characteristics that define a search request for records within the DRT 12 that correspond to the find specification. The general method for construction, saving and using a find specification is described in the U.S. patent application Ser. No. 09/712,581 entitled “Any-To-Any Component Computing System.”

Specifically, buttons records having certain parameters may be located by specifying their respective records using the “menu” field of the DRT 12, which can either contain a vector or (preferably) point to a list record containing the record list. Alternatively, button records having certain parameters may be located by running a find specification to locate buttons conforming to the specified parameters. Clicking a button causes the GUI controller to communicate this in the form of DRT records to underlying modules that fetch the button's DRT record and pass this record to the command matcher module, which then uses that record as a find specification to locate the appropriate execution record or records in the DRT 12 for that button. More specifically, the command matcher module uses the button's DRT record received indirectly from the GUI controller as a find specification, which the command matcher uses to locate the appropriate execution records in the DRT 12 for that button. The command matcher then supplies the button's execution records to the kernel, which causes the compiled code contained in or referenced by the found execution records to execute.

Active elements operate in a similar manner, which means that the GUI controller accepts user interface commands as inputs, and outputs DRT records, which may be immediately passed to the command matcher module or stored and made available for reload later. This process may also work in the other direction, in which the GUI controller receives DRT records and inputs, and outputs commands that drive the GUI 18. The properties of an active element include, but are not limited to, background shape, size, location, image and color; border type and width; system text font, size, text colors and styles; user entered text font, size, colors and styles; mouse actions for clicks, drag and other effects; etc. Because properties are constructed in a modular manner, new properties can be added on the fly without reconstruction and when added, become immediately available to all active elements.

In the collection of code referred to as the GUI controller, each property has two logics. One logic may be used to return the value of the property, and another logic may be used to change the value of the property. Collectively, these logics constitute the run-time interface that allows the code underlying the data-handling execution records to have full control over every aspect of any active element on the screen. Hence, the GUI and GUI controller do not themselves take any independent action, but simply respond to the orders received from any underlying modules in the form of DRT records on the one hand, and, on the other, outputs whatever the user does in the form of DRT records, which are then used by the code of underlying execution records. Hence, the screen is able to respond to the orders of any underlying modules, so long as they communicate in the standard manner using DRT records. Feeding suitably changing parameters to the GUI controller 20 run-time interface results in animation; as examples of this, feeding a continuously changing series of coordinates results in an active element moving across the screen; feeding different size coordinates in a loop makes the active element appear to pulse, and so forth.

Hence, the active element editor is simply a view that calls certain logics to change property values through the run-time interface. Generally, the active element editor has an active element for each property or group of properties. The appearance or construction of an active element editor as it appears on the screen is irrelevant to the underlying functionality because the view of the active element editor is just another view that can be customized like any other and in an ExoBrain, everything that appears on the screen is either a view, or a part of a view. Active elements can communicate with one another, also using the run-time interface. For example, an active element can be created to work directly on another active element, or it can be configured to find another active element at run-time by name. This particular mechanism is typically used in the case of the active element editor, in which buttons are used to call other appropriate other active elements to be displayed, which constitute what appears as a menu launched by that button. These infrastructure modules allow the user, through the GUI 18 and the DRT 12 to control the EXOBRAIN system 10, to access and control all types of data and execute all types of code contained in or referenced by the DRT 12.

The infrastructure modules 22 also include a number of reusable lower-level modules 20 or logics 14 that the higher-level applications may incorporate by reference or call on demand to include the associated functionality in the higher-level applications without having to create multiple instances of the lower-level reusable functional units. For example, these functions may include save elements, find elements, item maker elements, the modules and logics needed to create and use view templates, and other lower-level reusable components as determined by the EXOBRAIN system developers. These infrastructure modules 22, in turn, are available to be called by or referenced by higher-level reusable functional units 24, such as math functions, time functions, e-mail functions, fax functions, text functions, view functions, communication functions, send functions, chat functions, share functions, chart functions, share functions, browse functions, save functions, find functions, and other higher-level reusable components as determined by the EXOBRAIN system developers. The logic components 14, the structure and function for recording and using data components 16, and the infrastructure modules 22 are typically created and used by EXOBRAIN system developers to create the user-accessible reusable functional units 24. These user-accessible reusable functional units 24, along with the individual data components 16, the single and multi record structures 20, and some of the infrastructure modules 22 may be accessed by non-programmer designers and end users to create the EXOBRAIN equivalent of commercial grade applications 26 of all descriptions. Typically, the logic components 14 are not made directly available for end users or program designers to access in the construction and manipulation of the higher-level applications 26. That is, professional program designers and end users are typically permitted access to the reusable functional units 24, the data components 16, the single and multi record structures 20, and some of the infrastructure modules 22, which they use to construct customized applications 26 of their own design.

Further, the higher-level reusable functional units 24 are typically designed so that they may be made generally available to users of all descriptions. Nevertheless, for commercial reasons depending on the target customers of a particular EXOBRAIN system or product, access to the reusable functional units 24 may be limited to professional designers who create the EXOBRAIN system equivalent of higher-level commercial grade applications 26, which in turn may be directly accessed by end users. These commercial grade applications 26 typically include at least a calculator application, a calendar application, an e-mail application, a fax application, a word processing application, a spreadsheet application, a database application, an application for sending data between host systems, an application for implementing chat between host systems, an application for sharing data among host systems, a charting application, a browser application, a remote save application, navigation applications, and other higher-level customized applications as determined by the EXOBRAIN system developers. However, the tool set made available to designers and end users alike is designed to allow all users to customize pre-configured application and create new applications from scratch. That is, end users and EXOBRAIN application designers may further customize and adapt the customized applications 26 to create highly configured applications and special use programs 28 for a virtually unlimited range of applications, or alternatively, may create such highly adapted applications from scratch using the reusable functional units 24, the data components, or component data structures and functions, or both, 16, the single and multi record structures 20, and the infrastructure modules 22. In addition, the end user-functionality 26, 28 of each user's EXOBRAIN system may be both created and modified by and for that particular user or use “on the fly” without having to recompile the underlying code.

Because the compiled software components are incorporated by reference into the DRT 12, and may optionally also be stored in it, the individual compiled components can be incorporated into many different software assemblies without having to maintain multiple instances of the compiled components and without having to write multiple instances of code that is similar in function, and essentially similar in construction but adapted for a different application. This reduces the size of the compiled code for sophisticated software by factors of hundreds or thousands and also reduces the number of sources, and hence the complexity and effort required to detect and correct “bugs” due to the absence of multiple very similar (but not identical) blocks of code performing essentially the same function but in different “applications.” In addition, new software may be written, and existing software may be altered “on the fly,” without having to interrupt the user sessions to recompile the underlying code. Further, pre-configured labels and other text items may be changed “on the fly” without having to interrupt the user sessions to recompile the underlying code and a further result is that any user can easily create and store multiple views for data items “on the fly” during an uninterrupted user session.

The practice of recording all of the parameters specifying a view as records stored in the DRT database 12 enables the views to be transmitted to other EXOBRAIN systems in a very compact form that transmits quickly, and in such a manner that they can be processed appropriately by the recipient EXOBRAIN system on arrival. This allows each user to exchange views with other users using e-mail, file sharing, electronic chat and other available mechanisms for exchanging electronic data. Because the views are implemented within the EXOBRAIN infrastructure, complex views including images, animations, sound, and executable activities may be transmitted from one EXOBRAIN system to another, and the views run properly when received during an uninterrupted user session. In some instances, a view may utilize a logic component that is not included in the receiving party's set of compiled logic components 14, or a data component that is not included in the receiving party's set of data components 16. In this case, the receiving EXOBRAIN system can be set up to recognize this condition and to request a download of the missing component from the transmitting EXOBRAIN system or from elsewhere. This process, which can occur automatically during the on-going user session, seamlessly updates the receiving party's EXOBRAIN system. As a result, the received view can function properly when received or moments later.

The EXOBRAIN system described above represents a fundamentally new paradigm for software construction that solves the systemic problems encountered with conventional methods for assembling software. Many highly useful and previously unattainable software features and features only attainable with much greater difficulty of construction and use and cost and time can be implemented in this type of programming environment with greatly reduced construction time and difficulty, greatly reduced storage requirements, and greatly simplified maintenance and upgrading regimes as well as with greater simplicity for the user and greater transparency of the underlying mechanics for the user as well as overall power, as users can now construct their own applications without programmer assistance. In particular, the help items described below is one example of such a feature that becomes easier to enable in this environment.

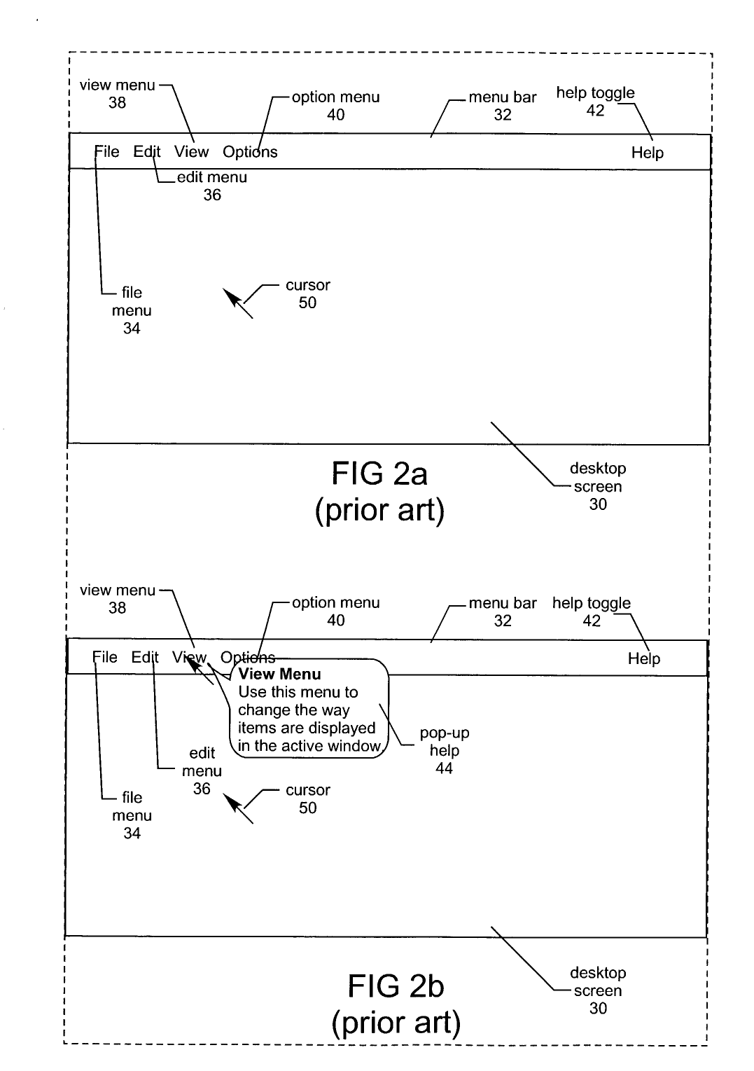

FIG. 2a shows a depiction of a prior art desktop screen 30 having a menu bar 32. On the menu bar are menus including: file menu 34, edit menu 36, view menu 38, option menu 40, and help toggle 42. This arrangement is similar to what is found on the Macintosh™ 8.0 operating system. A user may manipulate a cursor 50 and to access the various menus displayed as well as toggle the help bubbles on and off through help toggle 42. As shown in FIG. 2b, with the help toggled on, when the cursor 50 passes over a menu, such as view menu 38, a pop-up help bubble 44 will “pop up” and display a pre-configured help. However, as discussed prior, this is a single help item for the menu for every single user and a user can not modify the help nor can the user or the programmer add additional help levels, nor does such functionality serve as a means to activate further depth of explanation if the initial level is inadeqate .

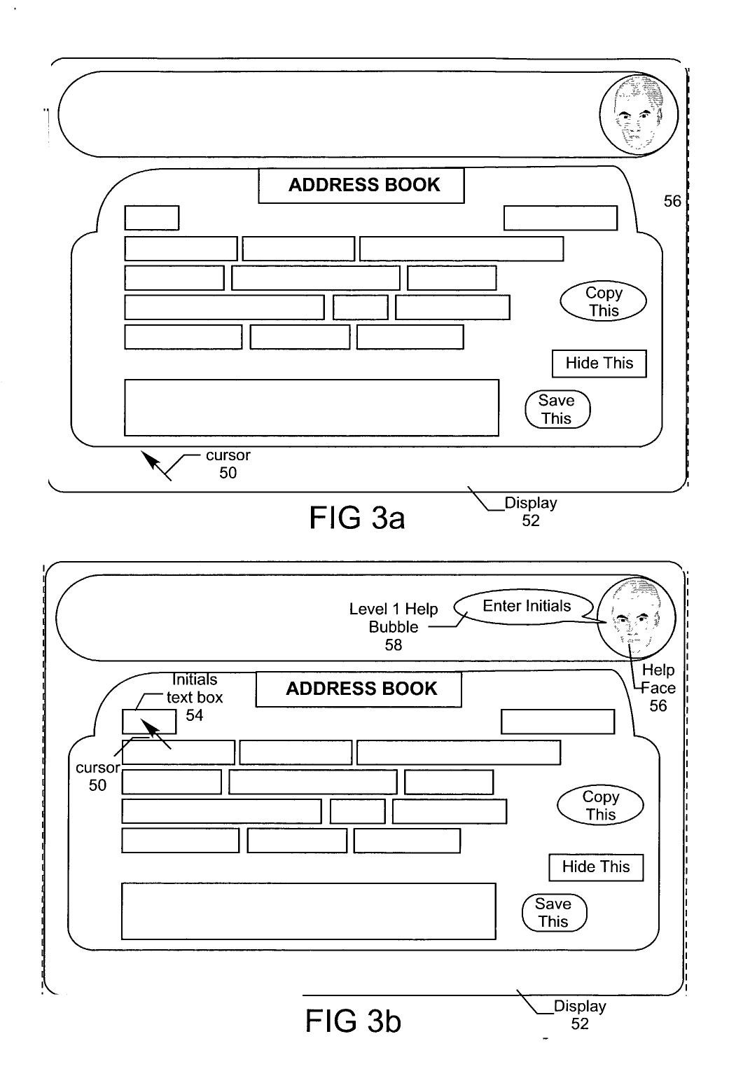

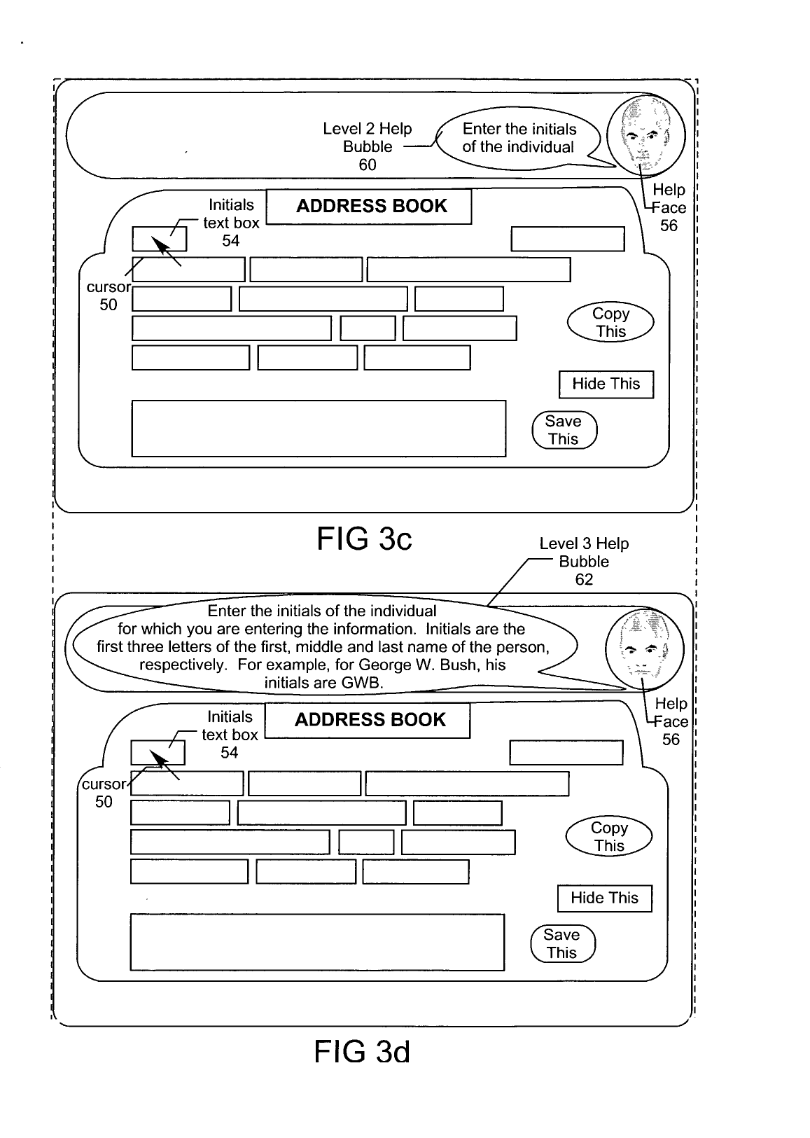

FIG. 3a shows a depiction of an embodiment of a user display 52 for the present invention. As shown, this is a view of an address book with various entry fields on a system display. As shown in FIG. 3b, the user may move cursor 50, and when moved over a display element, in the present example initials text box 54, the active element is activated. In the present example, upon activation of the element 54, a help item which is a level one help bubble 58, (but could equally be a help text that is independent of Ihelp level) is displayed. This help bubble 58 is shown adjacent to a help face 56. While not a necessary component for the present invention, the help face 56 may provide a more personalized and enjoyable experience for the user as well as enabling the designer to draw acceptance for his program by using celebrity faces under license and by providing a unique help experience. The help face 56 may also assist in drawing the user's attention to the help item. The level one help bubble 58 displays a simplistic help of “Enter Initials.” Additional help levels are associated with the element, initial text box 54, and are shown in FIGS. 3c-d. As shown in FIG. 3c, level two help bubble 60 displays the more verbose text of: “Enter the initials of the individual,” and, as shown in FIG. 3d, level three help bubble 62 displays the even more verbose text of: “Enter the initials of the individual for which you are entering the information. Initials are the first three letters of the first, middle and last name of the person, respectively. For example, for George W. Bush, his initials are GWB.” As shown, the help items for the various levels may become more detailed, or verbose in nature for increased help levels. One of these levels is preferably set as the initial, or the current, help level for that element.

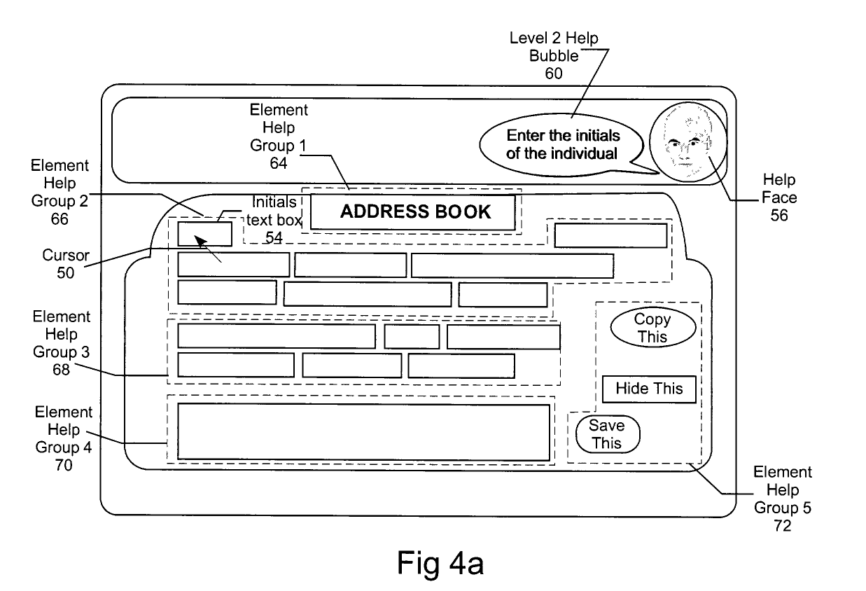

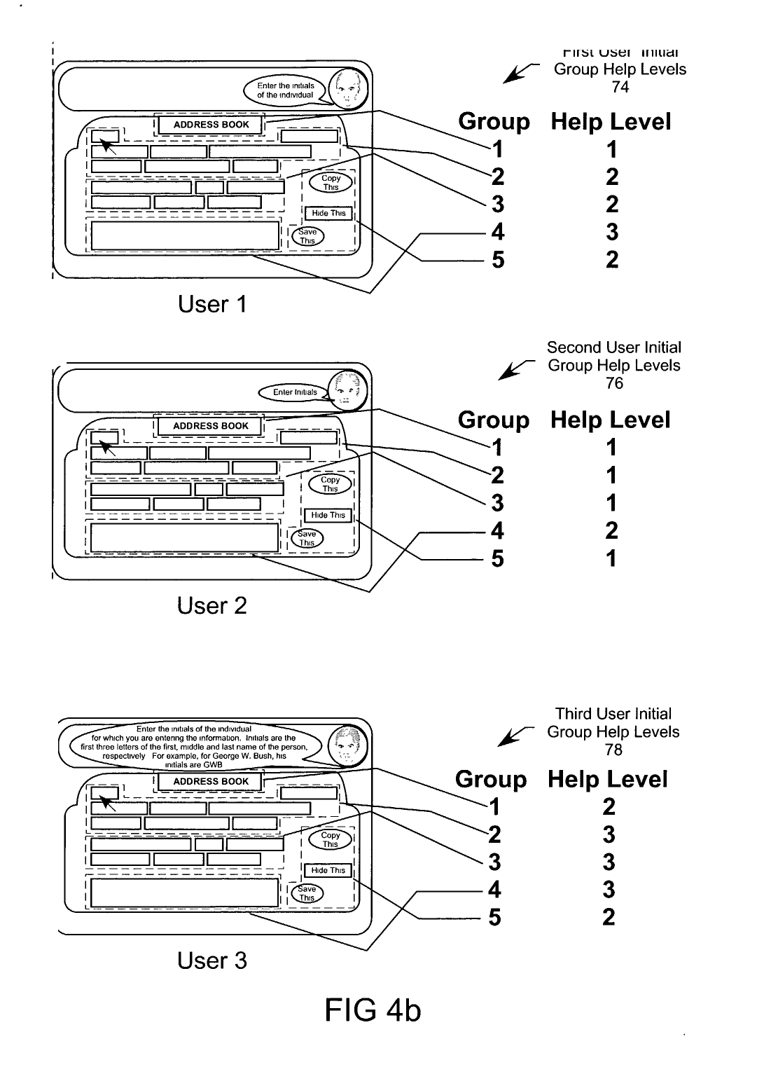

An alternative for determining the initial help items is to assign the elements into groups. As shown in FIG. 4a, for element help group 1 through element help group 5 66-72 the elements may be grouped into these element help groups 66-72 and, as discussed prior, the initial help level will be associated, to the user's initial help level for that group. As shown, initials text box 54 is associated with element help group 2 66. For this user, the initial help level for element help group 2 66 is the second help level. Therefore, when using groups, and upon activation of the element (the initial text box 54), the level two help bubble 60 is displayed adjacent to the help face 56.

Each user may have different help levels assigned to the groups. As shown in FIG. 4b, a first user's initial help levels 74 has an initial group help level of two for group two. However, a second user's initial help levels 76 shows that their initial help group level for group 2 is help level 1. Additionally, a third user, as shown in the third user's initial group help levels 78, has an initial help group level of three. It is important to note that these help group levels and the help groups themselves, need not be static and may change based on methodologies discussed prior.

As shown previously, the help item was shown in a “bubble” 58, 60, and 62. This bubble may be part of the help item, in as much as a help item may include a graphics, or the bubble may be part of a help window. For this reason a help window may be included as part of the help item. This means that any of the elements included with the help window, including control elements, may be incorporated, in their entirety, as part of the help item. However, in the subsequent discussion the term help window will be used with the understanding that the help window may be part of the help item, rather than a separate element to the help item.

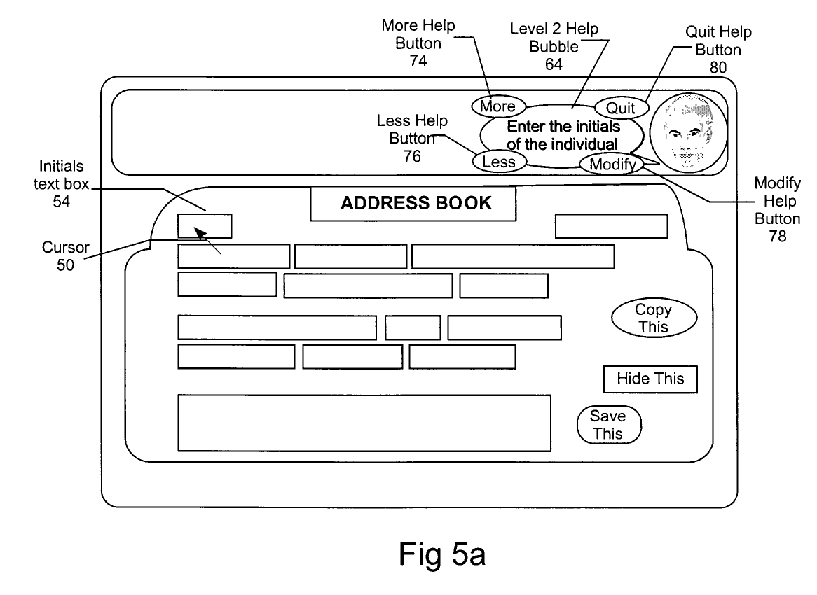

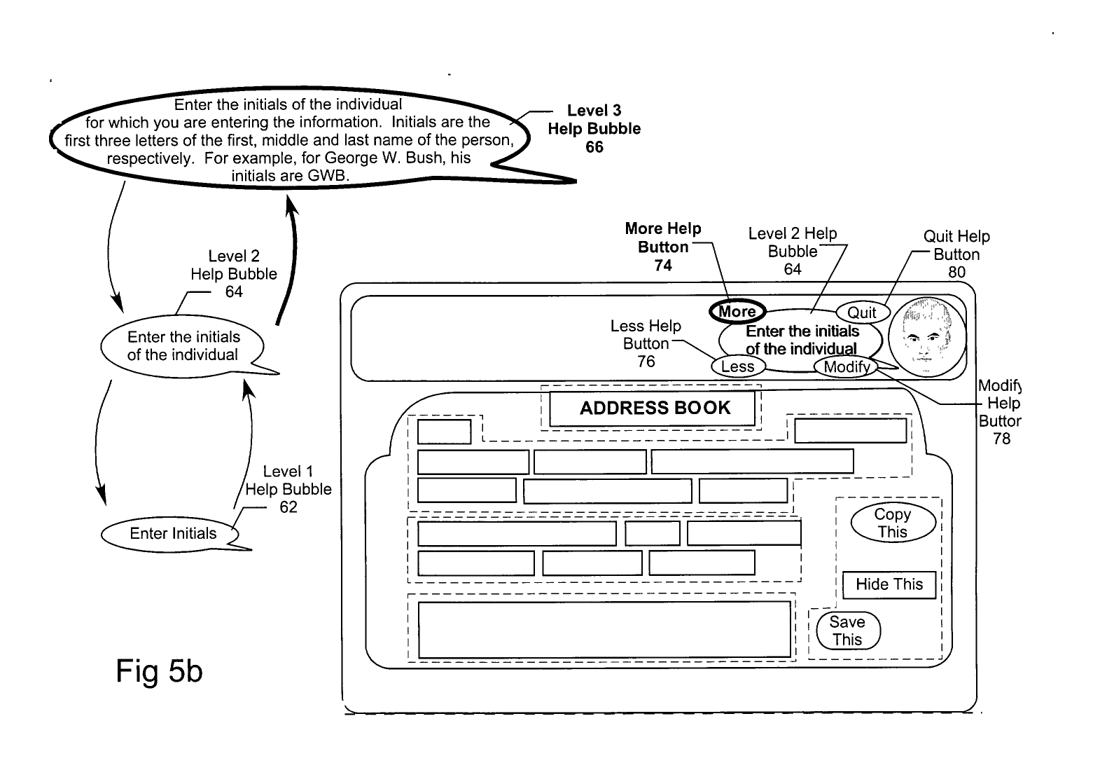

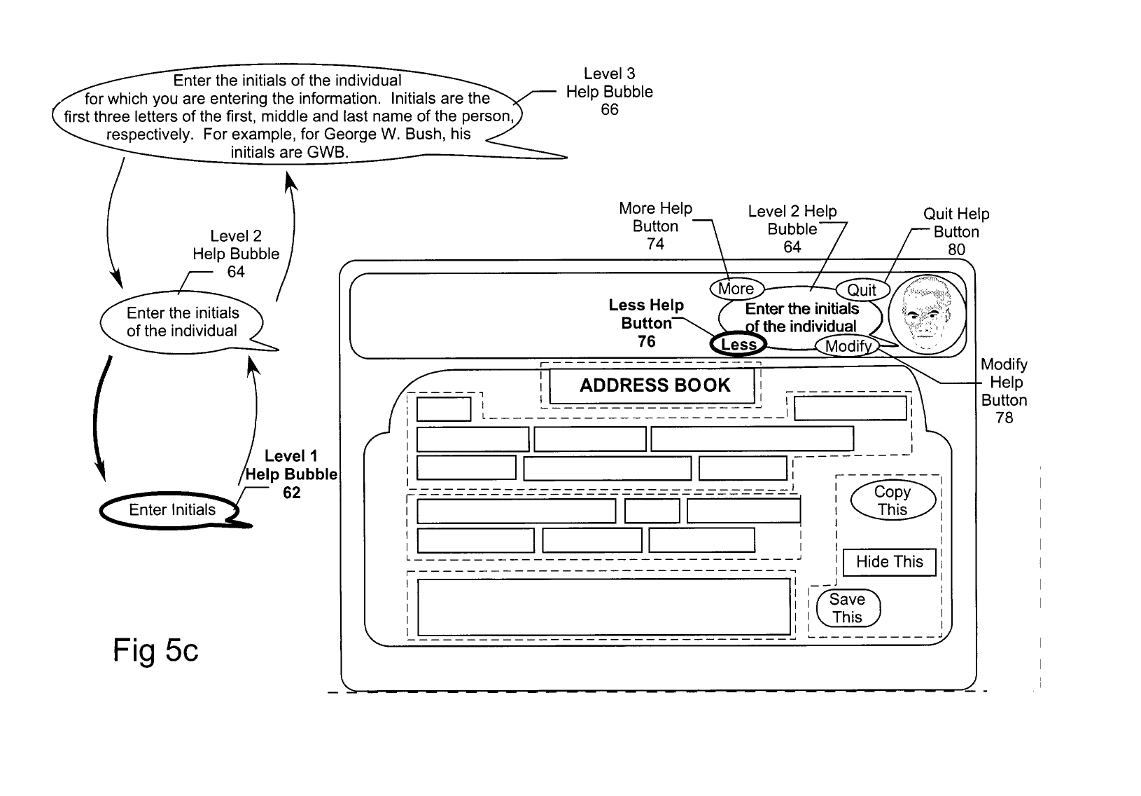

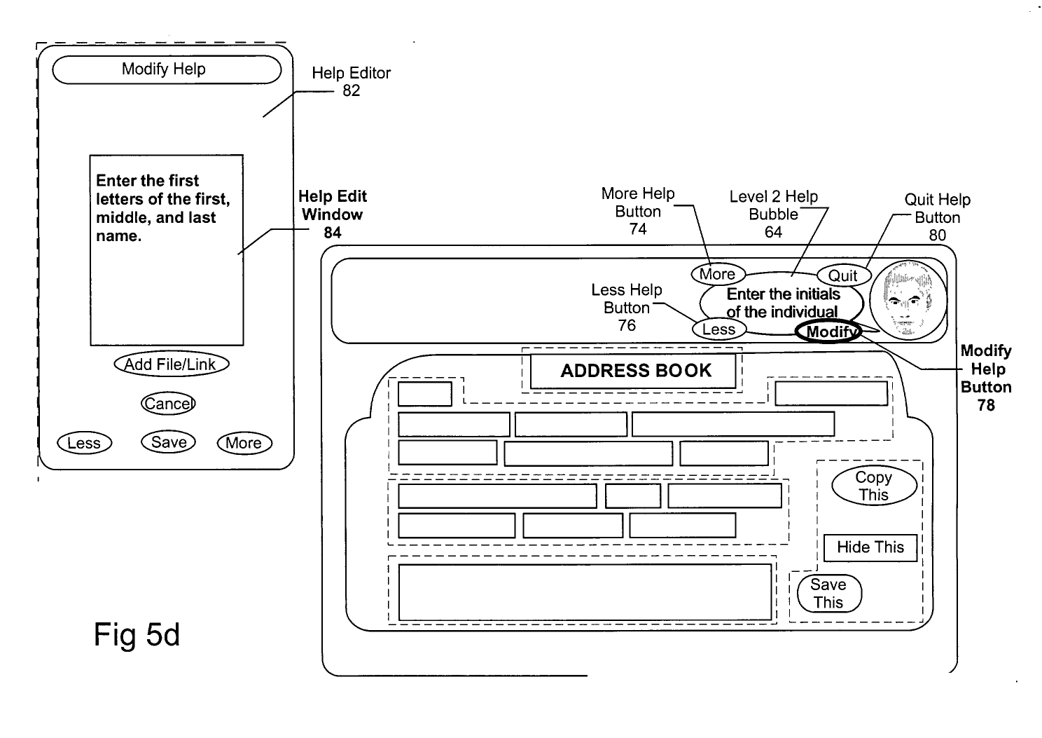

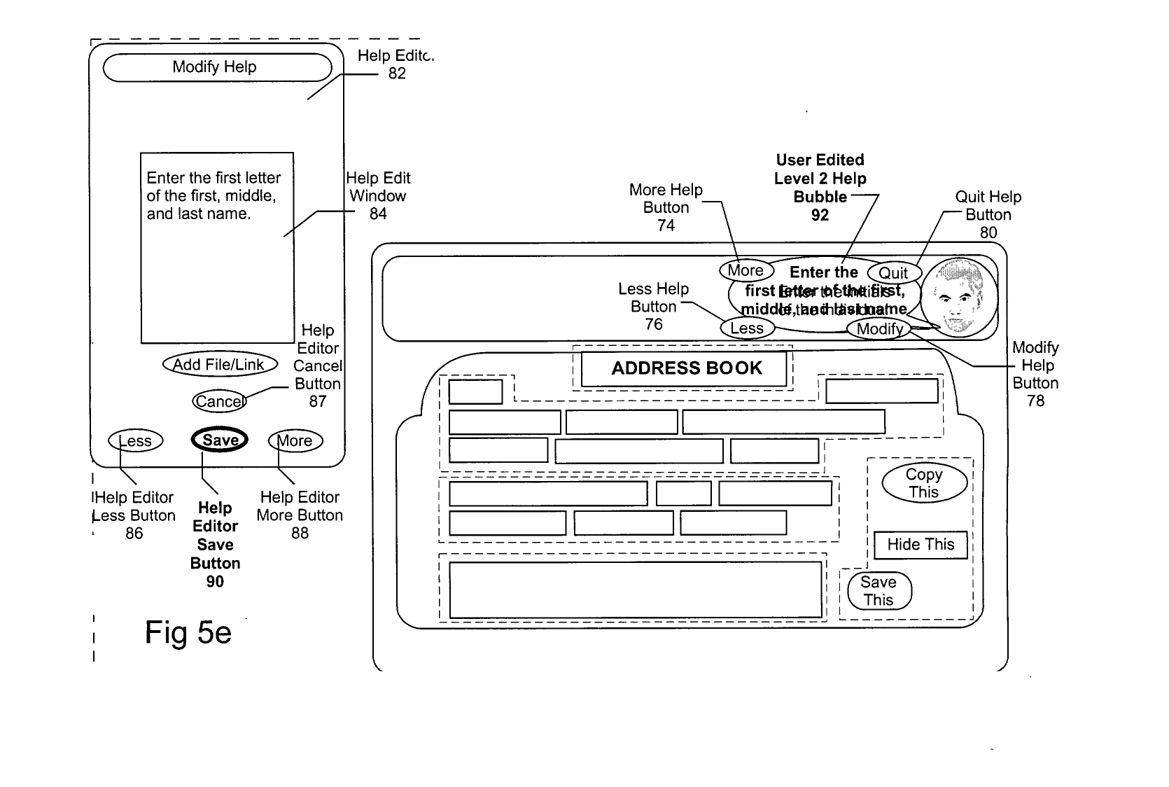

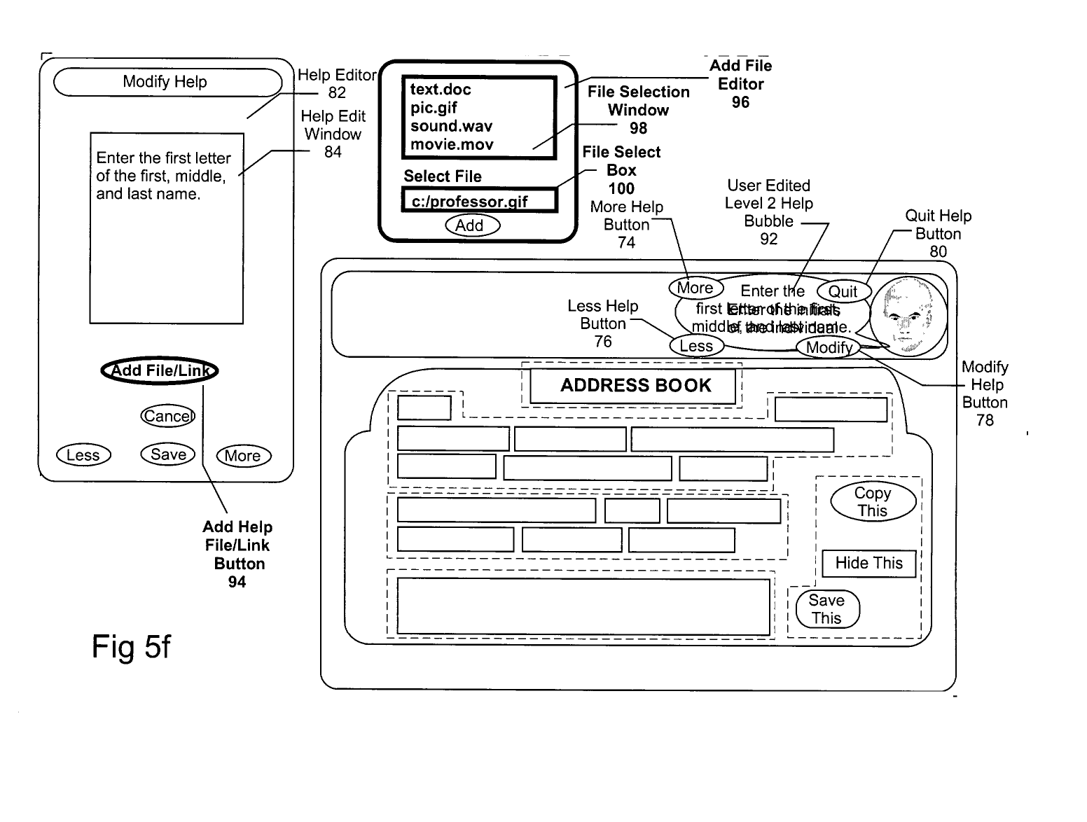

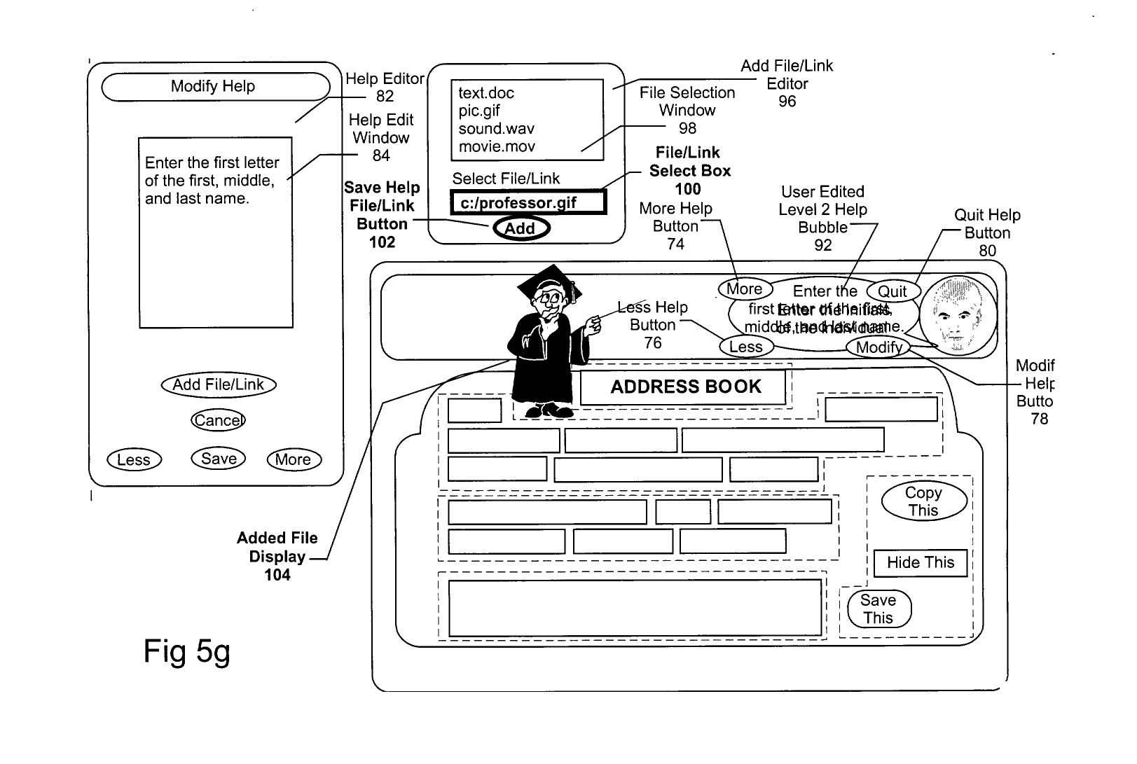

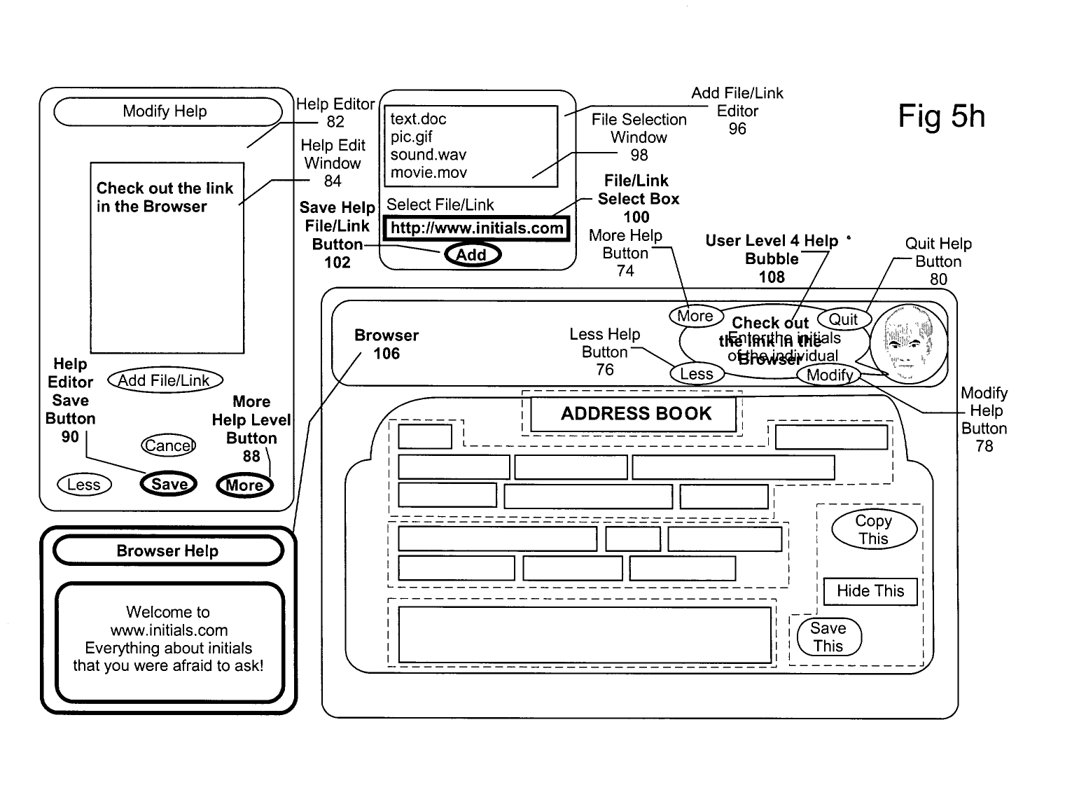

As shown in FIG. 5a, control elements may be added to the help window in any customary manner or using the active element editor previously described. In the present embodiment these control element are buttons 74-80. The more help button 74 allows a user to increase the help level. The less help button 76 allows a user to decrease the help level. The modify help button 78 allows a user to initiate a help item edit utility. The quit help button 80 allows a user to quit or close the help window.

As shown in FIG. 5b, when the more help button 74 (emphasized in bold) is selected the help level goes from the level 2 help bubble 64 to the level 3 help bubble 66 (emphasized in bold). As shown in FIG. 5c, this process can decrease the help level, by selecting the less help button 76 (emphasized in bold). When selected, the help level decreases from the level 2 help bubble 64 to the level 1 help bubble 62 (emphasized in bold). If additional levels were present, or created subsequently, the user could scroll to these levels in this manner.

As shown in FIG. 5d, selection of the modify help button 78 (emphasized in bold) initiates a help edit utility, a help editor 84 (emphasized in bold) in the present example. A user then may enter text (emphasized in bold) into a help edit window 84 (emphasized in bold). In the present example, the user entered the text of: “Enter the first letters of the first, middle, and last name.” As shown in FIG. 5e, upon selecting the help editor save button 90 (emphasized in bold) saves the user-edited help text. This saved text is then displayed in the user-edited level 2 help bubble 92 (emphasized in bold). The text displayed is part of a user-edited help item.

In another embodiment, a selection utility may be displayed, allowing the user to select between the user-edited help item or items and the default help item for that help level of the element. Additionally, this utility may be utilized to allow the user to select between the user-edited help items, regardless of who created them, and the default help item. For example, the selection utility might allow a user to select between the pre-configured help item, a user-edited help item, and one or more third-party edited help items. This third party may be another user or a “professional” third party that creates help items and language translations of help items. Access controls may be placed on the help items to allow or disallow access of the items, limit access to certain users, or allow or disallow editing of various help items.

As shown in FIG. 5f, a file or link may be added to the help item beginning with the selection of a add file/link button 94 (emphasized in bold). This selection activates an add file editor 96 (emphasized in bold). The add file editor 96 includes a file selection window 98 and a file select box 100. The user may select the file to add from the file selection window 98 or simply enter the file or link into the file/link select box 100. In the present example, the file “professor.gif” (emphasized in bold) was entered into the file/link select box and the save help file/link button 102 (emphasized in bold and labeled with “Add”) is selected and saves the file “professor.gif” and links it to the user-edited help item, user edited level 2 help bubble 92. The file, professor.gif, is then an added file display 104 (emphasized in bold) and displayed along with the associated help item 92. This added file may have its own associated properties, including size, placement, color and the like.

Alternatively, the user may add a link. As shown in FIG. 5h, a link may be entered into the file/link select box 100 and added to the link by selecting the save help file/link button 102. In the present example, the link “http://www.initials.com” is entered. This particular Uniform Resource Locator (“URL”) is only an example and should not be viewed as instructive as to the site actually displayed in accordance with this example URL. As this is a link, a Browser 106 is initiated to display the URL in a user-viewable format. Accordingly, the link may be to an executable and may include a command, file or link to use or access. In the present example, the executable (the browser) and a link (the URL of “http://www.initials.com”), which is initiated when displaying the associated file or link to the help item. It should be noted, that in this example the more help level button has been selected twice, thereby scrolling the help level to level four from the previous level, level two. As shown previously, only three pre-configured help levels were present. This allows for creation of a fourth level. The user then entered text into the help edit window. In the present example the text entered was “Check out the link in the Browser”. This text was saved by selecting the help editor save button 90, and subsequently displayed in the user level 4 help bubble 108. Help may also be enabled in such a manner that the user can always add another level if he wishes.

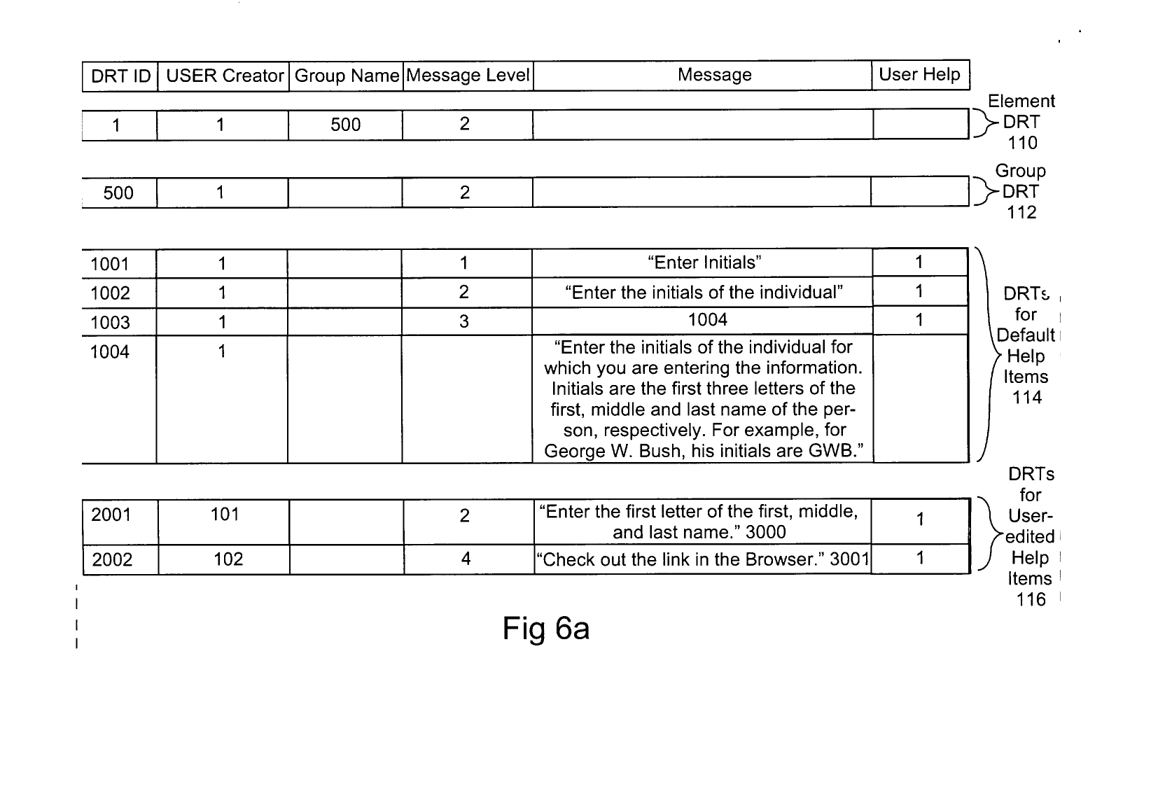

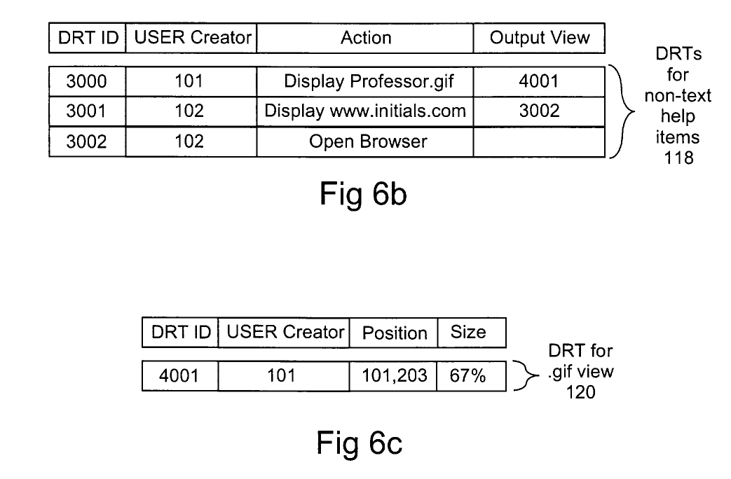

As discussed prior, this may be performed “on-the-fly” and may utilize DRT tables, such as those found in the EXOBRAIN™ system. FIG. 6a displays a “scaled-down” version of DRT records for the element, grouping and the associated help items. As a DRT record typically has hundreds of fields, only a handful of fields are shown for clarity and visualization. One skilled in the art will appreciate that additional administrative fields may be utilized to specify, among other things, the type, subtypes, classes and subclasses of DRT record that exists. Additionally, the formatting and the link fields and records are not shown, but should be understood to be a part of each of these records. The formatting fields and records provide specification of the formatting type of information including font, size, shape, color, background, position and the like. Commonly-owned U.S. patent application Ser. No. 09/712,581 entitled “Any-To-Any Component Computing System” and commonly-owned U.S. patent application Ser. No. 09/710,826 entitled “Graphical User Interface” and incorporate these by reference and these provide an in-depth discussion of the DRT tables and their utilization and can be referenced for a more complete understanding.

The displayed DRT system in FIGS. 6a-6c are simply examples for a single embodiment for the DRT system and should only be viewed as a conceptual use of the DRTs. The headers selected for discussion in FIG. 6a are:

the Record ID field, which provides a unique identifier for the record;

the USER Creator field, which identifies the user who created the record;

the Group Name field, which identifies to which group the element is assigned;

the Help Level field, which identifies with which help level the record is associated for help item DRTs and the “default” help level for the element or group; and

the Help fields, which provides the help text, or a DRT record link or a combination thereof, for the help item

The element DRT 110 shows a DRT ID with a 1 and a User creator identified by the numeral 1. In the present example, user 1 is the non-programmer designer or first user. The element is assigned a Group Name of 500, by the setting of the group name field to the numeral 500. This enables suitably constructed software to interpret these numerals as “links” that it uses to link the group to the DRT record with the DRT ID of 500, which is the group DRT 112. The Help Level field has the numeral 2, a setting that appropriate software can interpret as the “default” help level value is set as level two. Alternative embodiments may have a user specific value for each “default” or “last used” help level for each element or for any group.

Element DRT 110 has a blank help level field and help field, as they are not pertinent to the element in this embodiment. Alternatives may include placing in this field the number of a specific help level, as the “default” for the element, but which can be overridden by user specification.

The group DRT 112 has a Record ID field with a 500, and a User Creator field with a 1, showing that the software developer, or a designer, or a first user created this group. The help level field has a 2, signifying the default help level for any element of the group to be “two.” The remaining fields are not need in this illustration and are left blank

The DRT records for default help items 114, show sequential Record ID entries of 1001-1004 and all being created by user 1. The numerals in the help levels identify their respective help levels. One should note that the DRT Record with the Record ID of 1003 links to another DRT record, that of DRT record with the Record ID of 1004, in 1003's help text field. The DRT Record, with the record ID of 1004, then provides the actual text message. The user help field for the first three records all show a user help value of 1, which shows they all are “help items” for the element with the Record ID of 1. Alternatively, a “class” or “sub-class” field or fields may be used to specify that a record is a “help item.” Any record, and a record that is identified by a class or sub-class field(s), may contain a link or reference to the record of the element for which it provides help.

The DRT records for user-edited help items 116 have two DRT records, having Record ID values of 2001 and 2002. The first DRT record has a value of 101 for the user creator, and the second DRT record has a value of 102, thereby showing that user 101 created the first record 2001 and user 102 created the second record 2002. The help level numeral for the first item is set as “two” representing the second help level. This corresponds to the user edited level two help bubble 92 as the help text for this item is the message displayed for the help bubble 92. The help text field also contains pointer to a DRT record with an ID number of 3000.

Turning to FIG. 6b, we can see records of the DRT for non-text help items 118. These records of the DRT may have a multitude of fields, but again for the sake of brevity and clarity only four (4) fields are shown. The first two fields shown are the same as in FIG. 6a. The third field shown is that of the Action field. This field states the action that is to be done by appropriately configured software. While, in the present embodiment, an actual action is entered into the field, one should appreciate that a links to other records in the DRT may also be placed in conjunction with the actions or alone. The “linked” records typically could include an action or series of actions to perform. The fourth field is that of the output view field, which either provides the specifications for output formatting or provides a link to the formatting.

In the DRT record number 3000, which is linked from record number 2001 of the DRT (utilized for the user edited level 2 help bubble 92), the action field has the value “Display Professor.gif.” The corresponding output view for the record points to DRT record number 4001. This record is shown in FIG. 6c. In this description, the term “link” or “linked” can be an actual link, or a reference number that refers to another record number or to a field number or both. The record or field is then read and used by appropriately configured software to perform the activity that the ‘link’ requires. This reference number is preferably utilized in the EXOBRAIN system.

As before, FIG. 6c is an abbreviated field display of the Record ID and user creator fields, as well as a position field and a size field. It should be understood that other fields are normally present, but these two fields were selected from the possible fields only to provide an understanding without encumbering the reader with a multitude of fields. Record 4001 of the DRT, shows in the user creator field that user 101 created this record, the same user who created records 3000 and 2001, from which record 4001 links. The position field has a value of “101,203”, which the system, in this example, may read as the respective X and Y system display positions. Size field, in this example, provides the value the respective size to display the linked record, in this case 67% of the original value. This is the same as the added file display 104 as shown in FIG. 5g.

Turning back to FIG. 6a, and specifically to the DRT record with the Record ID value of 2002, a user creator value indicates creation by user 102. The message level shows a value of 4 with a message value of “Check out the link in the Browser.” This corresponds to what is shown in the user level four help bubble 108 of FIG. 5h. The message also has a link to record number 3001 or the DRT, directing us to FIG. 6b yet again. Record number 3001 has an action value of “Display www.initials.com” along with an output view value of 3002. This directs us to DRT record number 3002, which has an action value of “Open Browser.”

Therefore, when record 2002 or the DRT is called, it is for the fourth help level (user created) for element associated with record number 1 of the DRT, the message “Check out the link” is place in the help bubble 108, and the link “www.initials.com” results in the browser displayed 106 both as shown in FIG. 5h.

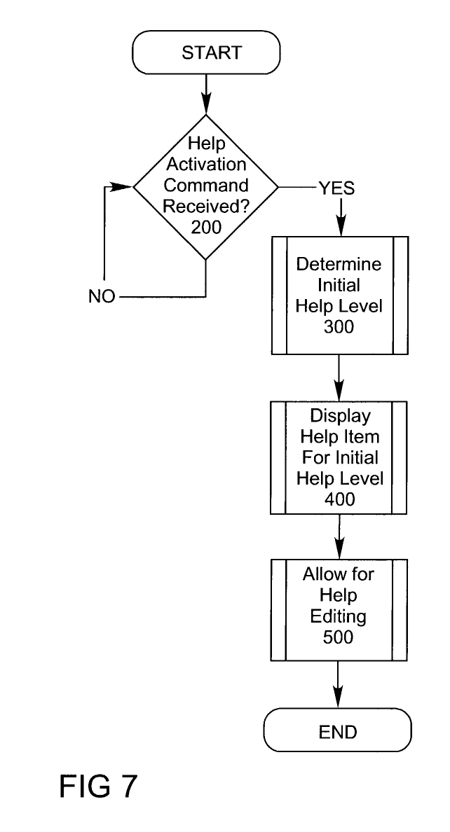

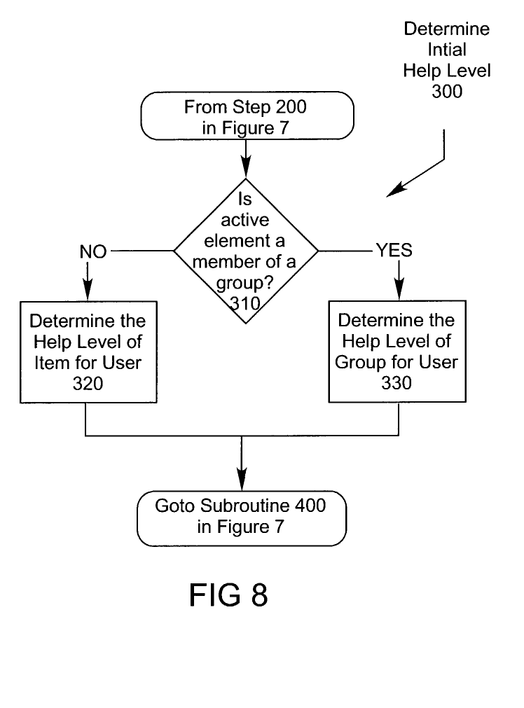

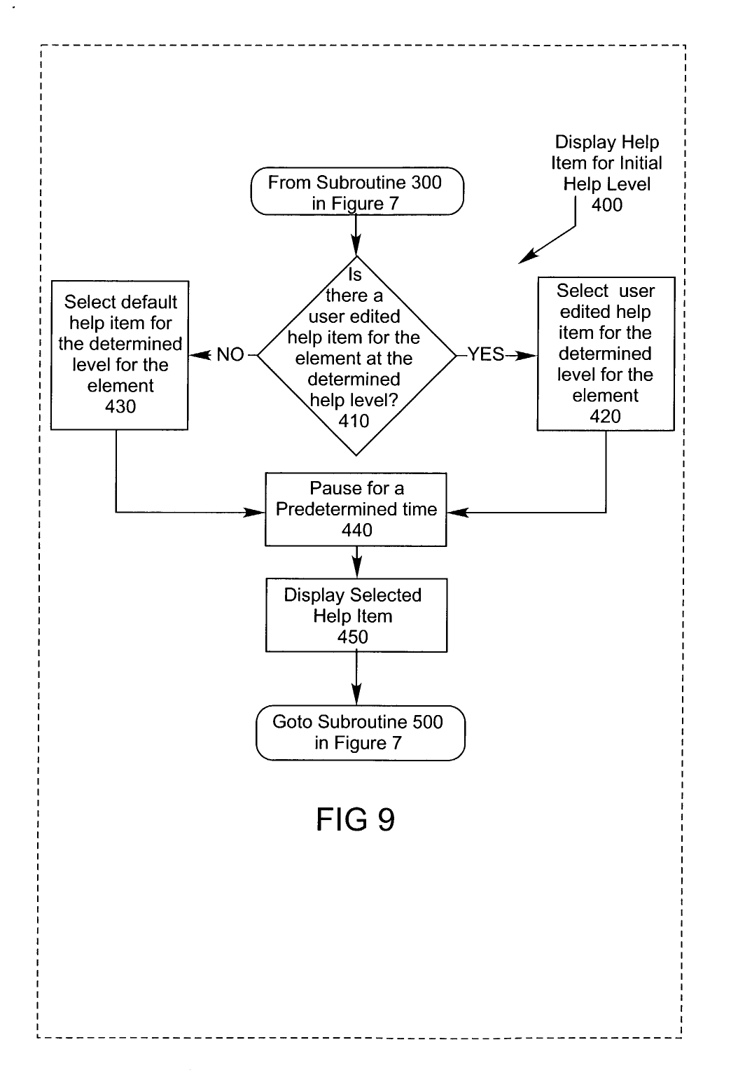

Turning the reader's attention to FIG. 7, this figure depicts a logical flow chart of an embodiment of practicing the present invention. It should be appreciated by those skilled in the art that the steps and subroutines in the follow logical flow chart, may be implemented as depicted, or preferably, as independent processes, typically initiated or activated by the user or by interrupt commands or the like.

Following from the Start step is decision step 200, which determines if there is a help activation command. If no help activation command is present, then decision step 200 is repeated until the initial event triggering help activation command occurs. This is essentially an interrupt notification of a help activation command. When a help activation command is received, subroutine 300 is performed. Subroutine 300 determines the initial help level.

As shown in FIG. 8, subroutine 300 has a first decision step 310, which determines if the active element is a member of a help group. If the element is a member of a group, then the “yes” branch is followed to step 330, which determines the help level of the group for the user. Alternatively, if the element is not a member of a group, then the “no” branch is followed to step 320, which determines the help level of the element for the user. Subroutine 400 follows both steps 320 and 330.

As shown in FIG. 9, Subroutine 400 has a first decision step 410 which determines if there is a user edited help item for the element at the determine level. If there is an element, the “yes” branch to step 420 is followed where step 420 selects the user edited help item for the determined level. However, if there is not a user-edited help item for the element at that level, then the “no” branch is followed to step 430, which selects the default, or pre-configured, help item for the determined level for the element. Step 440 follows both step 420 and step 430. Step 440 pauses for a predetermined time period. This pause is preferably utilized as the activation method for the present embodiment is to place a cursor over the screen element and it is preferable to ensure that only desired help items are displayed and that undesired help item display routines are not spawned. One skilled in the art will appreciate that the spawning, and subsequent displaying, of such multiple help items will produce an unwanted processor overhead as well as possibly being distracting to the user. This “pause” step could follow decision step 200 (or be included therein) to assure that the cursor has remained “over” the screen element for the required minimum time period.

Step 450 follows step 440 and displays the selected help item in the format associated with the help item. Subroutine 500 then follows step 450.

Subroutine 500 may be run as a parallel process or as an independent process. It may be preferable to run subroutine following the display of the selected help item to assist in user understanding of the process and not allow the user to be able to edit the various help items until being display the available help items.

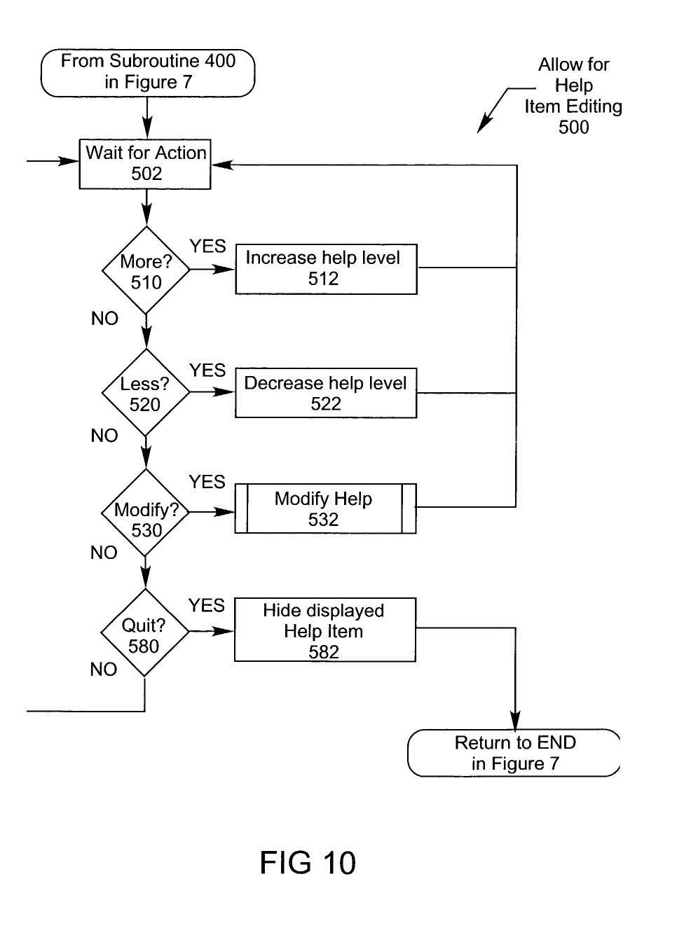

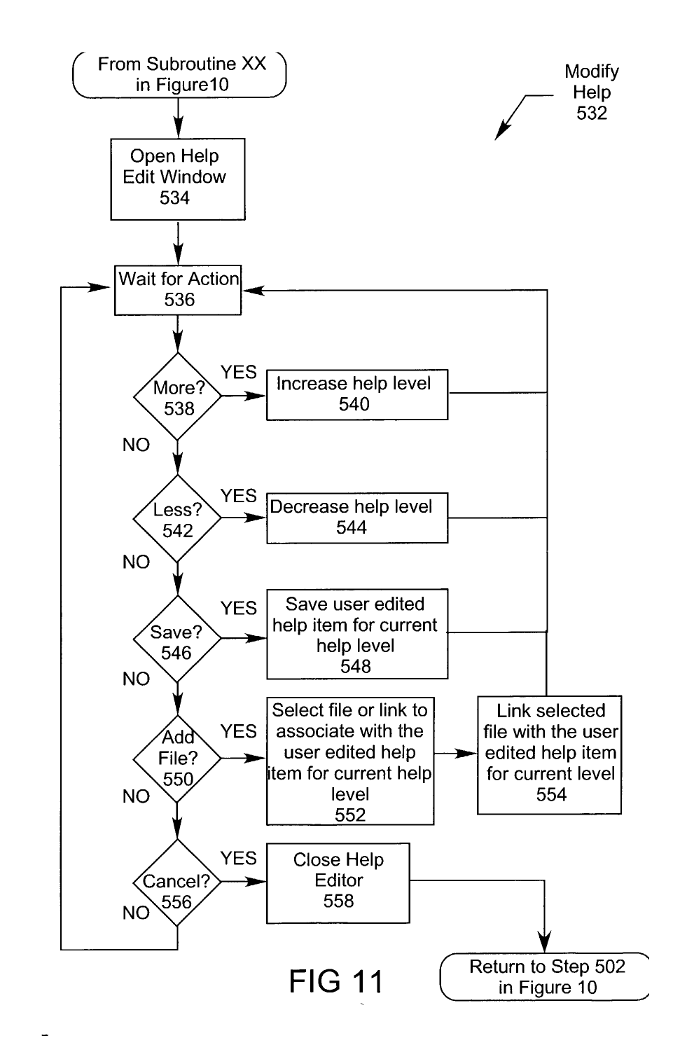

As shown in FIG. 10, subroutine 500 has a first step 502, which waits for an action. This step can be a series of decision steps or, “if-then” statements for steps 510, 520, 530, and 580, as shown, or as individual interrupt functions for the various control elements of the help window.

Decision step 510 follows step 502 and determines if the more help button 74 is selected. If it is, the “yes” branch is followed to step 512, which increases the help level. Step 512 returns to step 502 upon completion. However, if the more help button 74 is not selected the “no” branch is followed to decision step 520.

Decision step 520 determines if the less help button 76 is selected. If it is, the “yes” branch is followed to step 522, which decreases the help level. Step 522 returns to step 502 upon completion. However, if the less help button 76 is not selected the “no” branch is followed to decision step 530.

Decision step 532 determines if the modify help button 78 is selected. If it is, the “yes” branch is followed to subroutine 532.

As shown in FIG. 11, subroutine has a first step 534, which opens, a help edit window or otherwise enables the screen to enter help edit mode. Step 534 is followed by step 536, which waits for an action in a similar nature a discussed prior. In the present embodiment, some of the control elements of the help window are utilized in the editing process to save screen space and reduce the number of steps a user needs to do in order to achieve his objective. Specifically, the more help button 74 and the less help button 76 are utilized to increase and decrease the help level being viewed and edited (as opposed to being separately displayed as a part of the help edit window). Decision step 538 follows step 536 and determines if the more help button 74 is selected. If it is selected, the “yes” branch is followed to step 540, which increases the help level. Step 540 returns to step 536 upon completion. However, if the more help button 74 is not selected the “no” branch is followed to decision step 542.

Decision step 542 determines if the less help button 76 is selected. If it is selected, the “yes” branch is followed to step 544, which decreases the help level. Step 544 returns to step 536 upon completion. However, if the less help button 76 is not selected the “no” branch is followed to decision step 546

Decision step 546 determines if the help editor save button 90, of the help editor 82, is selected. If it is selected, the “yes” branch is followed to step 548, which saves the user edited help item for the current help level. Step 544 returns to step 536 upon completion. However, if the less help button 76 is not selected the “no” branch is followed to decision step 550.

Decision step 550 determines if the save help file/link button 102, of the add file/link editor 96, is selected. If it is selected, the “yes” branch is followed to step 552, which selects the file or link to associate with the user-edited help item for the current help level. Step 552 is followed by Step 554 which links the selected file with the user edited help item for the current level. Step 554 returns to step 536 upon completion. However, if the save help file/link button 102 is not selected the “no” branch is followed to decision step 556.

Decision step 556 determines if the help editor cancel button 87, of the help editor 82, is selected. If it is selected, the “yes” branch is followed to step 558, which closes the help editor 82. Step 548 returns to step 502 of FIG. 10 upon completion. However, if the less help button 76 is not selected the “no” branch is followed back to step 536.

Returning the readers attention back to decision step 530, as shown in FIG. 10, if the modify help button 76 is not selected the “no” branch is followed to decision step 580. If the quit help button 80 is selected, the “yes” branch is followed to step 582 which then hides the currently displayed help item. Additionally, the “quit” function could be signaled by the activation of another element. One should understand that multiple help windows may not be desirable as the may distract the user and hog memory and processor time. Step 582 is followed by returning to the END step of FIG. 7.

Note that FIGS. 7-11 are flow diagrams which form a logical plan for the construction of the corresponding software. This software may be constructed in the classic fashion, in which case the constructed software itself is similar in appearance to FIGS. 7-11. Alternatively, the software may be constructed in the EXOBRAIN fashion as described in the prior applications and technical letters incorporated herein by reference. In the latter case, each routine and subroutine is independent from the other, and is activated either by the user pressing a displayed button, or by an event such as a cursor position, or by other means. In this case, the software written in the EXOBRAIN fashion is written in such a way that where the code is to perform its function is known as this is driven by data recorded in DRT Records.

In view of the foregoing, it will be appreciated that the present invention avoids the drawbacks of conventional help item display for an element and provides a more effective and flexible method for display help items for an element to a computer user. It will also being appreciated that the present invention avoids the drawbacks of translating such text and enables this to be done on the fly, on screen and in-context. The specific techniques and structures employed by the invention to improve over the drawbacks of prior systems for receiving data through text boxes in a computer environment and accomplish the advantages described above will become apparent from the above detailed description of the embodiments of the invention and the appended drawings and claims. It should be understood that the foregoing relates only to the exemplary embodiments of the present invention, and that numerous changes may be made therein without departing from the spirit and scope of the invention as defined by the following claims

The invention claimed is:

1. A method for displaying help for an element, comprising the steps of:
creating a hierarchically organized plurality of help levels for the element in which each help level includes an associated help item;
receiving a help activation command associated with the element, and
in response to the help activation command, determining an initial help level when activating help for the element for a user and displaying the help item associated with the initial help level.

2. The method of claim 1, further comprising the step of displaying the help item within a help window.

3. The method of claim 2, wherein the help window comprises a help level scrolling element, wherein the help level scrolling element allows for user scrolling through other help levels associated with the element.

4. The method of claim 1, wherein the element is a screen element.

5. The method of claim 1, wherein the step of displaying the help item further comprising the step of displaying the help item substantially adjacent to the screen element.

6. The method of claim 1, wherein the help items include a pre-configured help item, further comprising the steps of:
receiving user input defining a user-edited help item for the element;
saving the user-edited help item; and
displaying the user-edited help item in response to a subsequent help activation command for the element.

7. The method of claim 6, wherein the user-edited help item comprises a new help item for a help level that did not previously have an associated help item.

8. The method of claim 6, further comprising the steps of:
retaining the pre-configured help item;
displaying a help item selection command including a first selection item corresponding to the pre-configured help item and a second selection item corresponding to the user-edited help item;
receiving user input selecting one of the first and second selection items; and
displaying the selected help item.

9. The method of claim 8, wherein the user-edited help item is a first user-edited help item, further comprising the steps of:
receiving user input define a second user-edited help item;
saving the second user-edited help item;
displaying a help item selection command including a first selection item corresponding to first user-edited help item, a second selection item corresponding to the second user-edited help item, and a third selection item corresponding to the pre-configured help item;
receiving user input selecting one of the first, second and third selection items; and
displaying the selected help item.

10. The method of claim 1, wherein the help items comprise text, graphics, video, sounds, links, applets or a combination thereof.

11. The method of claim 1, wherein the help item comprises a functionality for which a host system may launch.

12. The method of claim 1, wherein the step of determining the initial help level comprises the step of receiving user input specifying the initial help level for the element.

13. The method of claim 1, wherein the step of determining the initial help level comprises the step of setting the initial help level based on the most recent help level viewed by the user for the element.

14. The method of claim 1, wherein the step of determining the initial help level comprises the step of setting the initial help level based on the highest help level viewed by the user for the element during a period of interest.

15. The method of claim 1, wherein the step of determining the initial help level comprises the step of setting the initial help level based on a weighted averaged of help levels viewed by the user level for the element during a period of interest.

16. The method of claim 1, wherein the step of determining the initial help level comprises the step of setting the initial help level based on a group initial help level assigned to a group of related elements.

17. The method of claim 16, further comprising the steps of:
receiving user input defining the group of related elements; and
receiving user input setting the group help level.

18. The method of claim 16, further comprising the steps of:
defining the group of related elements based on similarities in the help levels viewed by the user for the elements of the group; and
setting the group initial help level based on an analysis of the help levels viewed by the user for the elements of the group.

19. The method of claim 18 wherein the applicable group initial help level is based on a weighted averaged of help levels viewed by the user for the elements assigned to the help group for a period of interest.

20. The method of claim 1 performed during an uninterrupted user session.

21. A computer storage medium comprising computer-executable instructions for performing the method of claim 1.

22. An apparatus configured to perform the method of claim 1.

23. A method for displaying help associated with an element on a computer interface comprising the steps of:
creating a plurality of pre-configured help items to provide varying degrees of help for the element;
assigning the pre-configured help items to respective help levels based on the degree of help provided by the respective items;
designating one of the help levels as an initial help level for a first user;
designating a different one of the help levels as an initial help level for a second user;
receiving a first help activation command from the first user, associated with the element, and in response, displaying the help item assigned to the initial help level for the first user; and
receiving a second help activation command from the second user, associated with the element, and in response, displaying the help item assigned to the initial help level for the second user

24. The method of claim 23, wherein:
the initial help level for the first user is specified by the first user; and
the initial help level for the second user is specified by the second user.

25. The method of claim 23, where the step of determining the initial help level for the first user comprises the steps of:
displaying a user help initialization screen;
receiving through the initialization screen user input connoting proficiency information concerning first user's proficiency in using the element; and
setting the initial help level for the first user based on the received proficiency information.

26. The method of claim 25 wherein the proficiency information comprises a user specified level of experience with the element.

27. The method of claim 25 wherein the proficiency information comprises information concerning the user's experience with a group of related elements.

28. The method of claim 23, further comprising the step of:
receiving input from the first user defining a first user-edited help item;
saving the first user-edited help item in association with a help level for the element;
receiving a help activation command, for the element, from the first user; and
displaying the first user-edited help item.

29. The method of claim 28, further comprising the step of:
receiving input from the second user defining a second user-edited help item;
saving the second user-edited help item in association with a help level for the element;
receiving a help activation command, for the element, from the second user; and
displaying the second user-edited help item.

30. The method of claim 29, wherein the first and second user-edited help items are displayed for the same element, assigned to the same help level, and include content that is different from each other.

31. The method of claim 30 further comprising the steps of:
displaying a help selection utility that permits the second user to view the first user-edited help item.

32. The method of claim 31 wherein the first user-edited help item comprises a language translation of a corresponding pre-configured help item.

33. The method of claim 32 performed during an uninterrupted user session.

34. A computer storage medium comprising computer-executable instructions for performing the method of claim 25.

35. An apparatus configured to perform the method of claim 28.

36. The method for displaying multi-user, multi-level and user-editable help for an element in an uninterrupted user session comprising the steps of:
creating a hierarchically organized plurality of help levels for the element in which each help level includes an associated help item;
receiving a first user input defining a first user-edited help item for the element;
saving the first user-edited help item;
receiving a second user input defining a second user-edited help item for the element;
saving the second user-edited help item;
receiving a first user help activation command, associated with the element, from a first user;
in response to the first user help activation command, determining an initial first user help level when activating help for the element and displaying the first user help item associated with the first user initial help level;
receiving a second user help activation command, associated with the element, from a second user; and
in response to the second user help activation command, determining an initial second user help level when activating help for the element and displaying the second user help item associated with the second user initial help level.

37. The method of claim 36 wherein the step of displaying the first user help item comprises the step of displaying the first user-edited help item.

38. A computer storage medium comprising computer-executable instructions for performing the method of claim 36.

39. An apparatus configured to perform the method of claim 37.
